(19) United States
(12) Patent Application Publication
(10) Pub. No.: US 2010/0129720 A1
(43) Pub. Date: May 27, 2010

(54) POLYOLEFIN MICROPOROUS MEMBRANE

(76) Inventors: Kentaro Sako, Tokyo (JP); Yoshifumi Nishimura, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/447,888

(22) PCT Filed: Oct. 30, 2007
(86) PCT No.: PCT/JP2007/071146

§ 371 Date: Jan. 7, 2010

(30) Foreign Application Priority Data
Oct. 30, 2006 (JP) 2006-294716

(51) Int. Cl. H01M 2/18; H01M 2/16; B29C 47/00

(52) U.S. Cl. 429/246; 429/254; 264/48

(57) ABSTRACT

Provided are a polyolefin microporous membrane having a thickness of from 1 to 100 μm, a pore diameter of from 0.01 to 1 μm, and protrusions having a height of from 0.5 to 30 μm formed by embossing on at least one of the surfaces of the membrane; a production method of the membrane; and a separator for battery made of the membrane.

### TECHNICAL FIELD

The present invention relates to a microporous membrane widely used as a separation membrane for separation or selective transmission of a substance or as a separator material of an electrochemical reaction apparatus such as alkaline battery, lithium ion battery, fuel cell, or capacitor. In particular, the invention pertains to a polyolefin microporous membrane suited for use as a separator for nonaqueous electrolyte battery.

### BACKGROUND ART

Polyolefin microporous membranes have been used for various purposes as a separation membrane for separation or selective transmission of various substances or a separator material. Examples of their usage include microfiltration membrane, separator for fuel cell or capacitor, base material of a functional membrane for causing a functional material to fill in pores of the base material and thereby causing the emergence of its new function, and a separator for battery. Above all, polyolefin microporous membranes are especially suited as a separator for lithium ion battery which is one of non-aqueous electrolyte batteries widely used in laptop computers, mobile phones, and digital cameras because they have mechanical strength and pore closing property.

As a negative electrode material of lithium ion batteries, carbon materials such as non-graphitizable carbon and graphite have conventionally been employed, but effective capacity of these carbon materials has already reached saturation from the standpoint of industrial technology and it is difficult to raise the capacity further by using them. In recent years, therefore, use of, as a new negative electrode material, so-called alloy negative electrode materials, for example, metals such as silicon (Si) or tin (Sn) or semi-metals disclosed in Patent Document 1 has been investigated.

Use of a metal such as silicon or tin, or a semi-metal for a negative electrode however deteriorates the cycle performance of the battery in an early stage because a volume change of the battery due to charging/discharging, in other words, an expansion factor or shrinkage factor is larger than that of carbon materials.

To solve the problem, Patent Document 2 discloses a technology of applying an electrolyte layer precursor solution in sol form to an electrode to form a gel electrolyte layer and thereby placing a space between a separator and the electrode. This method however needs a new step for this application so that it cannot provide inexpensive batteries.

Patent Document 3 discloses a method of improving the cycle performance of batteries using an alloy negative electrode by using, as a separator, a porous membrane made of a thermoplastic resin containing an inorganic filler. This method however does not succeed in sufficient improvement in the cycle performance.

Patent Document 4 describes a method for producing a polyethylene microporous membrane which is excellent in an electrolyte injection property and undergoes a small change in air permeability upon application of pressure by stretching a gel sheet and then, bringing a heated roll into contact with the sheet. In this document, it is described that a convex-concave roll may be used as a heated roll for improving a heating efficiency. Patent Document 5 discloses a method for producing a porous film made of a polyethylene resin by stretching a film, removing a plasticizer, heat treating the resulting film, and then embossing the film. This method aims to improve the handling property of the film and increasing the battery capacity. Patent Document 6 describes a separator for battery having, on the surface thereof, a convex or concave non-porous region.

When the microporous membranes described in these documents are used as a separator of lithium ion batteries, however, they may cause problems such as deterioration in battery capacity and generation of internal short-circuit failure.

Thus, polyolefin microporous membranes capable of realizing good battery properties when used as a separator for batteries, in particular, as a separator for batteries using an alloy negative electrode have not yet been available.

Patent Document 1: U.S. Pat. No. 4,950,566

### Patent Document 2: Japanese Patent Laid-Open No. 2006-156311

### Patent Document 3: Japanese Patent Laid-Open No. 2005-228514

### Patent Document 4: Japanese Patent Laid-Open No. 2007-106992

Patent Document 5: Japanese Patent Laid-Open No. Hei 11-106532

### Patent Document 6: International Patent Publication No. 05/022674

### DISCLOSURE OF THE INVENTION

### Problems to be Solved by the Invention

The present invention has been made in view of the above problems. An object of the invention is to provide a polyolefin microporous membrane capable of improving, in the production or usage of a nonaqueous electrolyte battery using an alloy negative electrode, the cycle performance of the battery at a low cost.

### Means for Solving the Problems

The present inventors have proceeded with an extensive investigation in order to achieve the above object. As a result, it has been found that when a polyolefin microporous membrane obtained by forming protrusions on the conventional polyolefin microporous membrane is used as a separator of a non-aqueous electrolyte battery with an alloy negative electrode, the battery can have improved cycle performance at a low cost. The following are the details of the present invention.

(1) A polyolefin microporous membrane having a thickness of from 1 to 100 μm, a pore diameter of from 0.01 to 1 μm, and having embossed protrusions having a height of from 0.5 to 100 μm on at least one of the surfaces of the membrane.

(2) The polyolefin microporous membrane as described above in (1), wherein the protrusions are porous.

(3) The polyolefin microporous membrane as described above in (1) or (2), having an air permeability of from 1 to 450 sec.

(4) The polyolefin microporous membrane as described above in any one of (1) to (3), wherein the protrusion height is from 0.5 to 20 μm.

(5) The polyolefin microporous membrane as described above in (1) or (2), wherein the membrane has an air permeability of from 1 to 340 sec and the protrusion height is from 0.5 to 20 μm.

(6) The polyolefin microporous membrane as described above in any one of (1) to (5), wherein the density of the protrusions is from 1 to 3000 pieces/cm².

(7) The polyolefin microporous membrane as described above in any one of (1) to (6), wherein the pore diameter is from 0.01 to 0.15 μm.

(8) The polyolefin microporous membrane as described above in any one of (1) to (7) obtained by a production method of a polyolefin microporous membrane comprising (i) a step of melting, kneading and extruding a polyolefin resin and a plasticizer, or a polyolefin resin, a plasticizer and an inorganic agent, (ii) a step of stretching the extrudate thus obtained, and (iii) a step of extracting the plasticizer or the plasticizer and the inorganic agent, wherein the production method comprises, prior to the stretching step (ii), a step of forming protrusions by embossing.

(9) A polyolefin microporous membrane with protrusions on at least one of the surface of the membrane, having a thickness of from 1 to 100 μm, a pore diameter of from 0.01 to 1 μm, protrusions on at least one of the surfaces of the membrane, and an area ratio X of from 1.001 to 3, the area ratio being represented by the following formula: X=S1/S2 (wherein, S1 represents an area of the surface of the membrane on a side having the protrusions and S2 represents a projected area corresponding to the same portion as S1).

(10) A production method of a polyolefin microporous membrane, comprising (i) a step of melting, kneading and extruding a polyolefin resin and a plasticizer, or a polyolefin resin, a plasticizer and an inorganic agent, (ii) a step of stretching the extrudate thus obtained, and (iii) a step of extracting the plasticizer or the plasticizer and the inorganic agent, which further comprises, prior to the stretching step (ii), a step of forming protrusions by embossing.

(11) The production method as described above in (9), wherein the embossing is performed at a temperature not greater than the melting point of the polyolefin resin.

(12) A separator for nonaqueous electrolyte battery, comprising the polyolefin microporous membrane as described above in any one of (1) to (9).

(13) A separator for alloy negative electrode lithium battery, comprising the polyolefin microporous membrane as described above in any one of (1) to (9).

(14) A nonaqueous electrolyte battery comprising a positive electrode and a negative electrode placed opposite to each other via a separator, wherein the separator for nonaqueous electrolyte battery as described above in (12) is used.

(15) A nonaqueous electrolyte battery comprising a positive electrode and a negative electrode placed opposite to each other via a separator, and an electrolyte filled in the battery, wherein the negative electrode comprises a negative electrode active material comprising a metal or a semi-metal which can be alloyed with lithium; and wherein the separator for an alloy negative electrode lithium battery as described above in (13) is used.

(16) A production method of a polyolefin microporous membrane, comprising (I) a step of molding or forming a polyolefin-containing resin composition into a sheet; (II) a step of stretching the resulting sheet, (III) a step of making the stretched sheet porous, and (IV) a step of embossing at least one of the surfaces of the sheet, wherein the step (IV) is performed prior to the step (II).

The reason why the cycle performance of a battery with an alloy negative electrode deteriorates in an early stage is presumably because a large volume expansion of the alloy negative electrode in battery charging/discharging compresses a separator and destroys its microporous structure.

When a polyolefin microporous membrane having protrusions is placed as a separator between positive and negative electrodes, the protrusions may serve as a pillar between the electrodes to provide an idle space which avoids the pore structures from collapsing when the negative electrode expands, and thus may suppress a deterioration of the cycle performance of the battery caused by expansion of the alloy negative electrodes.

When the protrusions are formed using an inorganic filler as in the conventional technology, however, there occur following problems, that is, (a) since protruding portions are made of an inorganic filler and are therefore rigid, they are not effective for absorbing a volume change even when they are compressed by expanded negative electrode particles; and (b) since protruding portions are made of an inorganic filler and have no ion permeability, ion can not permeate at a site where the protruding portions and the negative electrode particles contact, which deteriorates the battery capacity. Accordingly, it has been found that use of protrusions made of an inorganic filler does not bring about a sufficient effect for improving the cycle performance.

The present inventors have conceived an idea of overcoming the above problems that occurs when protrusions are made of an inorganic filler and improving the cycle performance of a battery by embossing a microporous membrane, thereby forming porous protrusions. In the present invention, the term “embossing” means converting the shape of the surface of a material into concavity and convexity, as is commonly understood.

When a thin stretched polyolefin microporous membrane is simply embossed as in the conventional technology (such as Patent Document 5), however, the microporous structure collapses due to the heat or pressure applied during embossing, thus it is difficult to achieve protrusions made of the microporous membrane itself by using this technology. Therefore, an ion permeability of the microporous membrane is reduced (air permeability is inceased) by simply embossing the membrane. A reduction in the ion permeability of the polyolefin microporous membrane leads to a reduction in a battery capacity when the membrane is used for a battery as a separator.

A polyolefin microporous membrane to be used as a separator of a lithium ion battery has generally a thickness of 30 μm or less. When such a thin membrane is embossed, a pressure greater than appropriate value is applied inevitably to the membrane since it is difficult to precisely control a pressure or distance between an embossing roll and a backup roll, thus the microporous structures tends to collapse. In addition, such a thin embossed membrane sometimes breaks at its concave portion during membrane formation and moreover, generates pin holes which may cause an internal short-circuit failure.

Because of the above reasons, reduction in battery capacity or internal short circuit failure is presumed to occur when a polyolefin microporous membrane embossed in accordance with the conventional technology is used as a separator of a lithium ion battery.

The present inventors have therefore performed an extensive investigation on such problems and found that a polyolefin microporous membrane with high permeability that is porous in both protruding portions and concave portions can be produced without generating pin holes or collapsing the microporous structure by (1) embossing a thick membrane before being stretched and (2) then, stretching the embossed membrane, and also found that when the membrane produced in such a manner is used in a battery as a separator, a cyclic performance comparable to that of a battery with a membrane embossed after being stretched can be achieved.

When the membrane is stretched after being embossed, protrusions once formed would change their shape by stretching. It was therefore believed that when a microporous membrane produced in such a manner was used as a separator for battery, it would not serve sufficiently as a pillar or an idle space which avoids the pore structures from collapsing when negative electrode expands and would not be effective for improving the cycle performance. However, a polyolefin microporous membrane obtained by embossing and then stretching shows unexpectedly an effect for improving the cycle performance comparable to that of the microporous membrane obtained by stretching and then embossing.

### EFFECT OF THE INVENTION

According to the polyolefin microporous membrane of the present invention, since protrusions contact with a positive electrode or a negative electrode, and it provides a space between the positive electrode and the negative electrode, the protrusions absorb a dimensional change of the negative electrode caused by its expansion in battery charging, thereby preventing compression or collapse of the polyolefin microporous membrane caused by expansion of the negative electrode at the space portion, resulting in improvement of the cycle performance of the battery. This effect is especially advantageous when the negative electrode is alloy-based, and it is also advantageous when the negative electrode is carbon-based. The presence of the above-mentioned space improves: the impregnation with an electrolyte, injection with an electrolyte, and retention of an electrolyte. This effect is more advantageous when the spacing between stacked electrode plates of the battery is small or a winding pressure of a wound electrode plate is high. In addition, due to the presence of the above-mentioned space, oxidation resistance of the polyolefin microporous membrane is also improved. This effect is more advantageous when the positive electrode active material has high oxidation property or a charging voltage is high. Further, the pore structure of the separator surface is densified by embossing, resulting in improvement in mechanical properties such as puncture strength and tensile strength. This effect is more advantageous when the separator is thin.

The production method of a polyolefin microporous membrane according to the present invention enables to produce a polyolefin microporous membrane suited for separator for battery as described above without collapsing the microporous structure or causing pinholes.

### BEST MODE FOR CARRYING OUT THE INVENTION

The present invention will hereinafter be described specifically by the following examples. It should however be borne in mind that the invention is not limited to or by these examples.

The polyolefin microporous membrane of the present invention produces a higher effect when used as a separator of a battery having a so-called alloy negative electrode. Such an alloy negative electrode is generally coated on one or both sides of a negative electrode current collector. On a non-coated portion of the negative electrode current collector, a tab can be formed, or the non-coated portion can be used as-is as a tab. As the negative electrode current collector, a metal foil such as copper foil is used.

The alloy negative electrode is a negative electrode comprising a negative electrode material having, as a component element thereof, at least one of metal elements and semi-metal elements that are capable of occluding, emitting, and alloying with an electrode reactive substance such as lithium, as a negative electrode active material. A high energy density can be achieved by using such a negative electrode material. This negative electrode material may be a metal element or a semi-metal element alone, or may be a compound or alloy thereof, or may be a material that comprises one or more of phase of these substances as a portion of the material. In the present invention, the term “alloy” includes, as well as an alloy made of two or more metal elements, an alloy made of one or more metal elements and one or more semi-metal elements. The alloy may contain a non-metal element. Its structure may be a solid solution, an eutectic crystal (eutectic point mixture), or an intermetallic compound, or a compound having at least two of them therein. The metal elements or semi-metal elements constituting this negative electrode material are, for example, metal elements or semi-metal elements capable of forming an alloy with lithium. Specific examples include boron, magnesium, aluminum, silicon, sulfur, titanium, vanadium, chromium, manganese, iron, cobalt, nickel, copper, zinc, gallium, germanium, yttrium, zirconium, niobium, molybdenum, palladium, silver, cadmium, indium, tin, antimony, hafnium, tungsten, platinum, gold, lead, bismuth, and gadolinium. The present invention can also be applied to a battery where a composite of the above alloy with carbon, silicon oxide, or amorphous substance is used as the negative electrode material. The negative electrode active material may be a metal lithium.

The thickness of the polyolefin microporous membrane of the present invention is 1 μm or greater from the standpoint of the strength of the membrane and is more preferably 5 μm or greater. On the other hand, it is not greater than 100 μm from the standpoint of permeability and is more preferably 30 μm or less.

The pore diameter of the polyolefin microporous membrane of the present invention is 0.01 μm or greater from the standpoint of electrolyte impregnation and is desirably 0.03 μm or greater. On the other hand, it is 1 μm or less from the standpoint of preventing internal short-circuit and is desirably 0.8 μm or less.

The microporous membrane of the present invention has protrusions on at least one of the surfaces thereof. The term “protrusion” as used herein means a portion protruded in a substantially convexed shape from a surface of a tabular polyolefin microporous membrane. The protrusions may be arranged either regularly or arbitrarily on the surface. The shape of the protrusions as viewed from normal direction to the surface of the polyolefin microporous membrane may be any shape such as dot, linear, or arc forms.

The term “protrusion height” means a difference in height between the base, that is, a flat portion of the membrane, and the top of the protrusion in the cross-section, including a protrusion, of the polyolefin microporous membrane.

The protrusion height of the polyolefin microporous membrane of the present invention is preferably 0.5 μm or greater, more preferably 1.5 μm or greater from the viewpoint of the size of active material particles of the alloy negative electrode. On the other hand, it is preferably 100 μm or less, more preferably 30 μm or less from the viewpoint of the thickness of a wound electrode plate. It is still more preferably 25 μm or less, still more preferably 20 μm or less.

In order to allow the protrusions formed on the polyolefin microporous membrane to absorb the volume expansion of the negative electrode, the protrusion height is preferably higher than a potential increase of the thickness of the alloy negative electrode layer. For example, the thickness of an alloy negative electrode layer in a lithium ion battery is usually from 5 to 50 μm. The alloy negative electrode expands from about 130% to 300% in volume during charging compared with that during discharging. The thickness of the alloy negative electrode layer accordingly shows an increase of from about 0.5 to 22 μm by the volume expansion. The protrusion height therefore desirably exceeds the above range.

The protrusion having an excessive height, on the other hand, increases the thickness of the polyolefin microporous membrane and therefore decreases the battery capacity per volume. The volume expansion of the alloy negative electrode is about 150% at most within an ordinary using range. An increase in the thickness of the negative electrode particle layer in this case is from about 0.7 to 7.2 μm, thus the above range is a more preferable range of the protrusion height in the present invention.

The protrusion height described above is however the optimum value in the actual battery production and the fact remains that the cycle performance can be improved effectively to some degree without causing a reduction in the battery capacity or an internal short-circuit failure, even if the protrusion height exceeds 100 μm or is below 0.5 μm.

The density of protrusions in the present invention will next be described.

If the density of protrusions as a pillar is too high, a large portion of the negative electrode is compressed by a separator due to expansion of the negative electrode, leading to deterioration in the cycle performance and rate performance. A size of the alloy negative electrode particles in a lithium ion battery is generally from 5 to 30 μm. In order to make the distance between each protrusions larger than the size of such alloy negative electrode particles, the density of protrusions is preferably 3000 pieces/cm² or less, more preferably 2500 pieces/cm² or less, still more preferably 2000 pieces/cm² or less.

Protrusions placed at a too low density, on the other hand, are not effective as a pillar, because the distance between each protrusions is too large. The density of protrusions is preferably 1 piece/cm² or greater, more preferably 5 pieces/cm² or greater, still more preferably 10 pieces/cm² or greater in order to obtain a pillar effect.

The porosity of the polyolefin microporous membrane of the present invention is preferably 30% or greater, more preferably 35% or greater, still more preferably 40% or greater from the standpoint of permeability. It is, on the other hand, preferably 70% or less, more preferably 60% or less from the standpoint of the membrane strength and withstand voltage.

The air permeability of the polyolefin microporous membrane of the present invention is preferably as low as possible. It is however preferably 1 sec/100 cc or greater, more preferably 50 sec/100 cc or greater from the viewpoint of a balance between thickness and porosity. On the other hand, it is preferably 1000 sec/100 cc or less, more preferably 500 sec/100 cc or less from the standpoint of permeability.

Embossing of a microporous membrane usually tends to collapse micropores and raise the air permeability due to a pressure or heat applied to the membrane during embossing. When stretching is performed after embossing, both protrusions-formation and low air permeability, more specifically, air permeability as low as 500 sec/100 cc or less, 450 sec/100 cc or less, or 340 sec/100 cc or less can be achieved.

The puncture strength of the polyolefin microporous membrane of the present invention is preferably 0.15 N/μm, more preferably 0.20 N/μm or greater. When the polyolefin microporous membrane having an excessively low puncture strength is used as a separator for battery, a sharp member such as electrode material punctures the microporous membrane and tends to cause pin holes or cracks. The puncture strength is therefore preferably as high as possible.

The tensile strength is preferably 300 kg/cm² or greater, more preferably 500 kg/cm² or greater in both a machine direction (which will hereinafter be abbreviated as MD) and a transverse direction (which will hereinafter be abbreviated as TD) of the membrane. The polyolefin microporous membrane with excessively low tensile strength may have problems such as deterioration in battery winding property or internal short-circuit caused by impact or foreign matters in the battery. In particular, absolute strength in the TD exceeding 1 kg/cm² is advantageous in a destructive test.

The MD and TD tensile elongations are preferably from 10 to 200%, more preferably from 10 to 150%, especially preferably from 10 to 120%. The sum of the MD tensile elongation and the TD tensile elongation is preferably from 20 to 250%, more preferably from 20 to 230%, especially preferably from 20 to 210%. The microporous membrane having the tensile elongations within the above range does not only provide improved windability when manufacturing a battery but also provides good resistance to deformation when the battery is tested with respect to impact.

A heat shrinkage at 65° C. of the polyolefin microporous membrane of the present invention is preferably 1% or less, more preferably 0.8% or less in TD in order to reduce shrinkage in the width direction of the microporous membrane in a battery drying step, battery high-temperature cycle test, battery high-temperature storage test, or the like.

In another preferred aspect of the present invention, a polyolefin microporous membrane having a thickness of from 1 to 100 μm, a pore diameter of from 0.01 to 1 μm, protrusions on at least one of the surfaces, and an area ratio X of from 1.001 to 3, the area ratio being represented by the following formula:

X=S1/S2 (1)

(in the formula (1), S1 represents an area of the surface of the membrane on a side having protrusions and S2 represents a projected area corresponding to the same portion as S1).

A technical significance of the area ratio of an area of the surface of the side having protrusions of the membrane to a projected area is as follows. At a fixed protrusion density, when a value of a protrusion size (R) approaches to a spacing (a) between two adjacent protrusions as viewed from membrane thickness direction, the percentage of a flat portion in the polyolefin microporous membrane becomes small and a portion compressed by the expanded negative electrode becomes large, resulting in reduction of the battery capacity. When (R) is excessively smaller than (a), on the other hand, the protrusions do not produce an effect as a pillar. Even when protrusion density and dimensional relationship between (R) and (a) are the same, the protrusion height (H) has a desirable range as described above. Regardless of difference in shape of the protrusions, their relationship can be expressed by the ratio X(X=S1/S2), a ratio of an area (S1) of the surface of the side having protrusions of a membrane to the projected area (S2) of the membrane as viewed from membrane thickness direction. The ratio can be from 1.001 to 3.000, preferably from 1.003 to 2.500, more preferably from 1.05 to 2.000.

A production method of a polyolefin microporous membrane according to the present invention will next be described.

In the present invention, no limitation is imposed on a molding or forming method of a polyolefin microporous membrane, a pore formation method, or a stretching method. Examples of the pore formation method include phase separation method, stretching pore formation method, dissolution recrystallization method, foaming method, and powder sintering method; examples of the extrusion method include inflation extrusion and die extrusion; and examples of the stretching method of the extrudate include monoaxial stretching, biaxial stretching (simultaneous or sequential), and cold/hot sequential stretching. For example, a polyolefin microporous membrane can also be produced by inflation extrusion or die extrusion followed by pore opening and stretching treatment by cold/hot sequential stretching.

The polyolefin microporous membrane according to the present invention may preferably be the production method of a polyolefin microporous membrane comprising (i) a step of melting, kneading and extruding a polyolefin resin and a plasticizer, or a polyolefin resin, a plasticizer and an inorganic agent (ii) a step of stretching the extrudate thus obtained; and (iii) a step of extracting the plasticizer or the plasticizer and the inorganic agent, wherein the method further comprises, prior to the stretching step (ii), a step of forming protrusions by embossing. No limitation is imposed on the kind of the polymer, kind of the solvent, extrusion method, embossing method, stretching method, extraction method, pore formation method, thermal fixation method, and heat treatment method insofar as the polyolefin microporous membrane having properties satisfying the present invention can be obtained.

In the production method of the present invention, the step (ii) and the step (iii) may be performed in reverse order or may be repeated any number of times. As described later, however, it is preferred to form protrusions by embossing prior to the step (ii) from the standpoint of preventing collapse of the microporous structure or prevention of generation of pin holes.

The preferred production method of the polyolefin microporous membrane according to the present invention will next be described. The microporous membrane of the present invention is available by the method having, for example, the following steps (a) to (f):

(a) A raw material selected from a polyolefin alone, a polyolefin mixture, a polyolefin solvent mixture or a kneaded polyolefin is melted and kneaded. If necessary, inorganic particles can be added to the raw material.

(b) The melt is extruded into a sheet, followed by solidification by cooling.

(c) The sheet thus obtained is embossed to form protrusions on at least one of the surfaces of the sheet.

(d) The embossed sheet is stretched in at least a monoaxial direction.

(e) After stretching, the plasticizer and inorganic particles are extracted as needed.

(f) The extraction is followed by thermal fixation or heat treatment as needed.

In the present invention, a similar effect is available by carrying out the embossing step (c) between extrusion and solidification by cooling in the step (b).

The method may comprise another embossing step after the step (e). In this case, one of the surfaces is embossed in the step (c), while the other surface is embossed after the step (e). This enables to add, to the membrane, a function other than that imparted by the present invention. Alternatively, by embossing the surface already embossed in the step (c) after the step (e), the function imparted through the present invention can become more sophisticated or be reinforced.

The polyolefin to be used in the present invention is a homopolymer of ethylene or propylene, or a copolymer of ethylene, propylene, 1-butene, 4-methyl-1-pentene, or 1-hexane and 1-octene or norbornene. It may be a mixture of the above polymers. Polyethylene and copolymers thereof are preferred from the standpoint of the performance of a resulting porous membrane. Examples of a polymerization catalyst for such a polyolefin include Ziegler-Natta catalysts, Phillips catalysts, and metallocene catalysts. The polyolefin may be either that obtained by one-stage polymerization or that obtained by multi-stage polymerization. The polyolefin to be supplied for the production contains preferably an ultra-high molecular weight polyolefin having a viscosity-average molecular weight (Mv) of 700000 or greater and a polyolefin having a MV not greater than 300000 because such a composition has both low fuse properties and high short-circuit properties. The polyolefin containing an ultra-high molecular weight polyolefin having an Mv of 1000000 or greater and a polyolefin having an Mv of 200000 or less is more preferred.

In addition, a known additive such as metal soap, e.g., calcium stearate or zinc stearate, an ultraviolet absorber, a light stabilizer, an antistatic agent, an antifog additive, or coloring pigment may be mixed.

In the present invention, inorganic particles typified by silica, alumina or titania may be added. These inorganic particles may be extracted wholly or partially in any of the above steps or they may be left in the product.

The solvent used in the present invention is an organic compound capable of forming a uniform solution with the polyolefin at a temperature not greater than the boiling point. Specific examples of the solvent include decalin, xylene, dioctyl phthalate, dibutyl phthalate, stearyl alcohol, oleyl alcohol, decyl alcohol, nonyl alcohol, diphenyl ether, n-decane, n-dodecane, and paraffin oil. Of these, paraffin oil and dioctyl phthalate are preferred. Although no particular limitation is imposed on an addition ratio of the plasticizer, it is preferably 20 wt. % or greater from the standpoint of the porosity of the membrane obtained and is preferably 90 wt. % or less from the standpoint of viscosity. It is more preferably from 50 wt. % to 70 wt. %.

An extraction solvent used in the present invention is preferably a poor solvent for the polyolefin, and is a good solvent for the plasticizer, and has a boiling point lower than the melting point of the polyolefin. Examples of such an extraction solvent include hydrocarbons such as n-hexane and cyclohexane; halogenated hydrocarbons such as methylene chloride, 1,1,1-trichloroethane and fluorocarbon, alcohols such as ethanol and isopropanol, and ketones such as acetone and 2-butanone. One or more extraction solvents may be selected from them and used either singly or in combination.

A total weight ratio of the plasticizer and the inorganic agent in the entire mixture to be melted and kneaded is preferably from 20 to 95 wt. %, more preferably from 30 to 80 wt. % from the standpoint of permeability of the membrane and film-forming property.

Addition of an antioxidant is preferred in order to prevent thermal deterioration during melting and kneading and preventing quality deterioration due to the thermal deterioration. The concentration of the antioxidant is preferably 0.3 wt. % or greater, more preferably 0.5 wt. % or greater based on the total weight of the polyolefin. It is, on the other hand, preferably 5 wt. % or less, more preferably 3 wt. % or less.

The antioxidant is preferably a phenolic antioxidant which is a primary antioxidant. Examples include 2,6-di-t-butyl-4-methylphenol, pentaerythrityl-tetrakis-[3-(3,5-di-t-butyl-4-hydroxyphenyl)propionate], and octadecyl-3-(3,5-di-t-butyl-4-hydroxyphenyl)propionate. A secondary antioxidant may also be used in combination and examples of it include phosphorus antioxidants such as tris(2,4-d-t-butylphenyl) phosphite and tetrakis(2,4-di-t-butylphenyl)-4,4-biphenylene diphosphonite, and sulfur antioxidants such as dilauryl-thio-dipropionate.

The melting and kneading, and extruding are performed in the following manner. First, some or all of the raw materials are mixed in advance in a Henschel mixer, ribbon blender, tumbler blender or the like as needed. If the amount of the raw materials is small, they may be mixed manually. Then, the resulting premixture is melted and kneaded in a screw extruder such as single screw extruder or twin screw extruder, kneader, mixer or the like, and then extruded through a T die or ring dye. The polyolefin microporous membrane may be formed as a stack of a plurality of membranes made of different materials by employing co-extrusion as a method of melting and kneading and extruding.

In the production of the polyolefin microporous membrane according to the present invention, it is preferred to substitute the atmosphere with a nitrogen atmosphere after mixing the raw material polymer with the antioxidant at a predetermined concentration, and melt and knead the mixture while keeping the nitrogen atmosphere. The melting and kneading temperature is preferably 160° C. or greater, more preferably 180° C. or greater. It is, on the other hand, preferably less than 300° C., more preferably less than 240° C., still more preferably less than 230° C.

The melt of the present invention may contain an unmelted inorganic agent which can be extracted in an inorganic agent extractions step. The melt which has been made uniform by melting and kneading may be passed through a screen in order to improve the quality of the resulting membrane.

The melt is then preferably formed into a sheet. Described specifically, the melt obtained by extrusion after melting and kneading is solidified by compression cooling. Examples of the cooling method include a method of bringing the melt into direct contact with a cooling medium such as cool air or cooling water and a method of bringing the melt into contact with a roll or press cooled with a refrigerant. The latter method of bringing the melt into contact with a roll or press cooled with a refrigerant is preferred because it is excellent in the control of thickness.

The sheet thus obtained is then re-heated and passed between pressure rolls having an embossed pattern to form a protruding precursor on the sheet. The heating temperature of the rolls is preferably 130° C. or less, more preferably 100° C. or less. The linear pressure between the rolls is preferably from 30 to 180 N/mm, more preferably from 60 to 150 N/mm. The pressure rolls may be a combination of an embossing roll and a plain backup roll (when embossing is performed on one side) or a combination of embossing rolls (when embossing is performed on both sides). When embossing is performed on both sides, embossed patterns may be different from each other.

To obtain porous protrusions without collapsing the microporous structure of the polyolefin microporous membrane, the temperature of the polyolefin microporous membrane is adjusted to preferably not greater than the melting point of the polyolefin resin. The term “melting point” as used herein is determined by the differential scanning calorimetry (DSC). When two or more peaks are observed, the temperature of the lowest peak, of the peaks belonging to the polyolefin, is taken as the melting point of the polyolefin resin.

For embossing, use of an embossing roll is preferred. The term “embossing roll” means a roll having, on the surface thereof, concave-convex patterns (embossed patterns) and the concave-convex patterns on the roll surface can be formed by a known means such as engraving (mill engraving, photo engraving, or the like), cup engraving, punching, grooving, slit or wire. As the material of the roll, metals or elastic materials (such as cotton, paper, resin, or rubber) are usable.

The characteristic of the use of the embossing roll is that the concave-convex patterns of the polyolefin microporous membrane thus obtained are formed periodically in at least the MD. No matter what embossed pattern the roll has, a polyolefin microporous membrane having thereon the concave-convex patterns repeatedly formed in the MD with a cycle corresponding to the circumferential length of the roll can be obtained.

Examples of the embossed pattern of the embossing roll include H patterns, diamond convex patterns, lattice convex patterns, square convex patterns, diamond patterns, horizontally long elliptical patterns, honeycomb patterns, skewered dumpling patterns, silk cloth patterns, diagonal lattice patterns, diagonal line patterns, vertical line patterns, and pleat patterns. Of these, diamond patterns, diagonal lattice patterns, skewered dumpling patterns, and honeycomb patterns are preferred, with the diamond patterns and diagonal lattice patterns being more preferred. The shape of the protrusion or protrusion group formed by embossing has a close relationship with the advantage of the present invention. For example, in an electrolyte injection step for fabricating a battery while utilizing the present invention, an electrolyte injection rate can be raised by placing a protrusion group so as to be substantially parallel to the flow direction of an electrolyte. In addition, the flow of the electrolyte in a battery caused by a volume change of the electrode during charging/discharging can be made smooth by placing the protrusion group so as to form a flow passage of the electrolyte.

The mesh and depth of the embossed pattern can be adjusted to from 1 to 500 pieces/inch and from 0.01 to 10.0 mm, more preferably from 10 to 450 pieces/inch and from 0.02 to 5.0 mm, still more preferably from 20 to 300 pieces/inch and from 0.03 to 1.0 mm, respectively. In some embossed patterns, pitch and repetition length can each be adjusted to from 0.1 to 10.0 mm, preferably from 0.5 to 5.0 mm, still more preferably from 1.0 to 3.5 mm.

The embossing is followed by stretching and extraction of the plasticizer or followed by stretching, extraction of the plasticizer, and extraction of the inorganic agent. Thermal fixation or heat treatment may be performed as needed. No particular limitation is imposed on the order, method and frequency of these steps.

When the sheet contains a plasticizer upon embossing, it becomes difficult to form protrusions because the plasticizer stays in the concave portion of the embossing roll. In such a case, embossing is performed while removing the plasticizer from the embossing roll by using a suction roll, whereby the protrusions can be formed on the surface more easily.

Examples of the stretching method to be used in the present invention include MD monoaxial stretching with a roll stretching machine, TD monoaxial stretching with a tenter, sequential biaxial stretching with a combination of a roll stretching machine and a tenter or a tenter and another tenter, and simultaneous biaxial stretching using a simultaneous biaxial tenter or blown film extrusion. The draw magnification in terms of a total area magnification is preferably 8 times or greater, more preferably 15 times or greater, most preferably 40 times or greater from the standpoint of uniform membrane thickness.

The polyolefin microporous membrane of the present invention may be a multilayer membrane made of different raw materials, which is obtained by laminating a plurality of sheets including an embossed sheet prepared as described above and then stretching the laminate. In this case, the embossed sheet may be used as an inner layer, but it is preferably adhered to one of the outermost layers.

In the extraction of the plasticizer, the plasticizer is extracted by immersing the membrane in an extraction solvent or showering the membrane with an extraction solvent. Then the membrane is dried thoroughly.

For thermal fixation or heat treatment, a relaxation operation is performed at a predetermined relaxation rate in a predetermined temperature atmosphere. It can be performed using a tenter or a roll stretching machine.

The term “relaxation operation” means a contracting the membrane in the MD and/or TD. The term “relaxation rate” means a value obtained by dividing the MD size of the membrane after the relaxation operation by the MD size of the membrane before the operation; a value obtained by dividing the TD size of the membrane after the relaxation operation by the TD size of the membrane before the operation; or a value obtained by multiplying the relaxation rate of the MD by the relaxation rate of the TD when the membrane is relaxed in both the MD and TD. The predetermined temperature is preferably 100° C. or greater from the viewpoint of thermal shrinkage and preferably less than 135° C. from the standpoint of porosity and permeability. The predetermined relaxation rate is preferably 0.9 or less, more preferably 0.8 or less from the standpoint of thermal shrinkage. It is, on the other hand, preferably 0.6 or greater from the standpoint of prevention of wrinkles, porosity and permeability. The relaxation operation may be performed in both the MD and TD, but the thermal shrinkage can be reduced not only in the operation direction but also a direction vertical thereto by the relaxation operation in either one of the MD and TD.

In the present invention, the membrane can be subjected to surface treatment such as exposure to electron beam, exposure to plasma, application of a surfactant, or chemical modification.

It is also possible to coat the polyolefin microporous membrane of the present invention with an inorganic filler such as silica, alumina or titania, or a heat-resistant resin such as polyimide, polyamide, aramid, polyvinylidene fluoride, or polytetrafluoroethylene, or a mixture thereof. In this case, coating may be conducted in any of the above steps, but coating after extraction is especially preferred. When the inorganic filler is applied, it is preferable to use a binder. The inorganic filler and the heat-resistant resin may be coated while stacking one over the other.

Moreover, it is preferred to treat a master roll at a predetermined temperature after the thermal fixation and then carry out a rewinding step of the master roll. This step releases a residual stress of the polyolefin in the master roll. The heat treatment temperature of the master roll is preferably 35° C. or greater, more preferably 45° C. or greater, especially preferably 60° C. or greater. It is, on the other hand, preferably 120° C. or less from the viewpoint of permeability retention.

Physical properties and battery performances of polyolefin microporous membranes used in the invention were measured and evaluated based on the following methods.

### (1) Viscosity-Average Molecular Weight (Mv)

Intrinsic viscosity [η] was determined in accordance with ASTM-D4020 at 135° C. while using decalin as a solvent. The Mv of polyethylene was calculated in accordance with the following equation:

[η]=6.77×10⁻⁴Mv^{0.67}

The Mv of polypropylene was calculated in accordance with the following equation:

[η]=1.10×10⁻⁴ Mv^{0.80}

### (2) Membrane Thickness (μm)

The thickness of a membrane was measured at room temperature of 23±2° C. using a microthickness meter “KBM” (trade mark) manufactured by Toyo Seiki. In the invention, an entire thickness of a polyolefin microporous membrane in a thickness direction, that is, a distance from one surface to the other surface including the protrusion height was measured. The length measured by the microthickness meter was sufficiently longer than the distance between two adjacent protrusions. An average of the measured values was determined to be a membrane thickness.

### (3) Porosity (%)

A 10 cm×10 cm square sample was cut out from a polyolefin microporous membrane and its volume (cm³) and mass (g) were measured.

The porosity was calculated based on these values and membrane density (density of a material constituting the membrane) (g/cm³) in accordance with the following equation:

Porosity=(volume−mass/membrane density)/volume×100

The porosity was calculated using a constant value of 0.95 as the membrane density.

(4) Air Permeability (sec)

Air permeability was measured using a GURLEY air permeability meter (“G-B2”, trade mark, product of Toyo Seiki) in accordance with JIS P-8117. At the time of measurement, the pressure, membrane area, amount of air passing through the membrane, and temperature of the atmosphere were set 0.01276 atm, 6.424 cm², 100 cc, and 23±2° C., respectively.

### (5) Pore Diameter (μm) and Tortuosity Factor

It is known that fluid inside a capillary follows the Knudsen flow when its mean free path of the fluid is larger than the pore diameter of the capillary, whereas it follows the Poiseuille flow when its mean free path is smaller than the pore diameter of the capillary. It is therefore assumed that air flow in the measurement of air permeability of a microporous membrane follows the Knudsen flow and water flow in the measurement of water permeability of the microporous membrane follows the Poiseuille flow.

In this case, a pore diameter d (μm) and a tortuosity factor (dimensionless) can be determined in accordance with the following equation based on a permeation rate constant of air R_{gas}(m³/(m²·sec·Pa)), a permeation rate constant of water R_{liq}(m³/(m²·sec·Pa)), a molecular speed ν of air (m/sec), a viscosity η of water (Pa·sec), a standard pressure Ps (=101325 Pa), a porosity ε (%) and a membrane thickness L (μm):

d=2ν·(R_{liq}/R_{gas})·(16η/3 Ps)·106

τ²=d·(ε/100)·ν/(3 L·Ps·R_{gas})

R_{gas} can be determined using air permeability (sec) in accordance with the following equation:

R_{gas}=0.0001/(air permeability·(6.424×10⁻⁴)·(0.01276×101325))

R_{liq} can be determined using water permeability (cm³/(cm²·sec·atm)) in accordance with the following equation:

R_{liq}=water permeability/100/101325

The water permeability can be determined as follows: After a microporous membrane which has been immersed in an alcohol in advance is set in a stainless water-permeability cell having a diameter of 41 mm. The alcohol in the membrane is washed away with water, the membrane is permeated with water at a differential pressure of about 0.5 atom in a temperature atmosphere of 23±2° C. A water permeation amount (cm³) after an elapse of 120 seconds is measured. The water permeation amount per unit time,·unit pressure·and unit area is calculated, and the calculated value is determined to be the water permeability.

The ν can be determined using a gas constant R (=8.314), an absolute temperature T (k) of an atmospheric temperature, the circular constant π, and an average molecular weight M (=2.896×10⁻² kg/mol) of air in accordance with the following equation:

ν²=8RT/πM

With regard to the pore diameter of the membranes having a pore diameter exceeding 0.1 μm (Examples 14 to 17), the maximum pore diameter measured by the method in accordance with ASTM F-316-86 is taken as the pore diameter. Described specifically, a sample having a diameter of 75 mm is cut out from a polyolefin microporous membranes and immersed in ethanol at a temperature of 25±5° C. After substitution of the internal air in the pores with ethanol, pressure is applied. Pressure P at the time when air bubbles appear from the surface of the sample is read and the maximum pore diameter is determined in accordance with the following equation:

Maximum pore diameter=pressure constant×surface tension of ethanol/P

In the above equation, the pressure constant is 2860 and the surface tension of ethanol is 22.4.

### (6) Puncture Strength (N/μm)

A puncture test was performed with a handy compression test device “KES-G5” (trademark) manufactured by Kato Tech Co., Ltd. at a curvature radius of the needle point of 0.5 mm and a puncture rate of 2 mm/sec in a temperature atmosphere of at 23±2° C. and the maximum load (N) required to puncture a sample was determined to be its puncture strength. Puncture strength (N/μm) in terms of 1 μm membrane thickness was calculated by multiplying this value with 1/thickness (μm).

(7) Tensile Strength (kg/cm²) and Tensile Elongation (%)

Strength and elongation of a sample when it was ruptured in the MD and TD were measured using a tensile tester and Autograph AG-A (trademark) of Shimadzu Corporation in accordance with JIS K7127. The sample having a width of 10 mm and a length of 100 mm was cut out, a distance between chucks was adjusted to 50 mm, and one of the surfaces of each of the end portions (25 mm) of the sample were taped with cellophane tape (“N.29”, trade name; product of Nitto Denko Packing System). In order to prevent slip of the sample during the test, a fluoro rubber having a thickness of 1 mm was applied to the inside of the chuck of the tensile tester. The tensile strength (kg/cm²) was determined by dividing the strength at rupture by the cross-sectional area of the sample before the test. The tensile elongation (%) was determined by dividing the elongation (mm) at rupture by the chuck-to-chuck distance (50 mm) and multiplying by 100. Measurement was carried out at a temperature of 23±2° C., chuck pressure of 0.30 MPa, and stretching rate of 200 mm/min (at a strain rate of 400%/min for the sample for which the chuck-to-chuck distance of 50 mm can not be maintained).

### (8) Measurement of Height (μm), Shape and Density of Protrusion, and X Ratio

Surface height distribution of a polyolefin microporous membrane in a planar direction was measured by using a scanning white light interferometer “Zygo NewView 6300” (trademark); product of Cannon Marketing Japan), setting an object lens magnification at 2.5, and setting the length of each side of an observation field of view at least 3 times the expected distance between protrusions. The measurement was conducted at 23±2° C.

From the height distribution thus obtained, a difference in height between the base and top of each of all the protrusions present in the observation field of view was read and the average value was determined to be the projection height (μm).

A base is defined for each protrusion. An intermediate height between the highest root and the lowest root among roots around a protrusion is defined as a base of the protrusion.

Moreover, the shape of protrusions was observed from the three-dimensional reconstruction of the height distribution.

Based on the height distribution measured with the scanning white light interferometer, the number of the protrusions in the observation field of view was counted and density of protrusions (pieces/cm²) was determined by dividing the number with the area (S2) of the observation field of view.

In addition, based on the height distribution measured with the scanning white light interferometer, the area (S1) of the membrane surface within the observation field of view was determined. The area of the observation field of view was determined to be a projected area (S2) of the measured region, and an X ratio was determined in accordance with the following equation: X=S1/S2.

### (9) Evaluation of Battery Performance

Preparation of positive electrode: A mixture composed of 92.2 wt. % of lithium cobalt composite oxide LiCoO₂ as an active material, 2.3 wt. % of each of flake graphite and acetylene black as a conducting aid, and 3.2 wt. % of polyvinylidene fluoride (PVdF) as a binder was dispersed in N-methylpyrrolidone (NMP) to prepare a slurry. The resulting slurry was coated onto both surfaces of an aluminum foil having a thickness of 20 μm and serving as a positive electrode current collector by using a die coater, dried at 130° C. for 3 minutes and then compression molded by using a roll press. In the above step, the amount of coating of the positive electrode active material was adjusted to 250 g/m² and bulk density of the active material was adjusted to 3.00 g/cm³. The resulting foil was cut into strips having a width of 54 mm.

Preparation of negative electrode: A mixture composed of 85 wt. % of Co—Sn—C powder (element composition ratio: 10:50:40%) prepared by the mechanical alloying method as an active material, 5 wt. % of carbon black as a conducting aid, and 10 wt. % of PVdF as a binder was dispersed in NMP to prepare a slurry. The resulting slurry was coated onto both surfaces of a copper foil having a thickness of 12 μm and serving as a negative electrode current collector by using a die coater, dried at 125° C. for 3 minutes and then compression molded with a roll press. In the above step, the amount of coating of the negative electrode active material was adjusted to 53 g/m² and bulk density of the active material was adjusted to 1.35 g/cm³. The foil thus obtained was cut into strips having a width of 56 mm.

Preparation of nonaqueous electrolyte: A nonaqueous electrolyte was prepared by dissolving, in a mixed solvent containing ethylene carbonate and ethyl methyl carbonate at a ratio of 1:2 (volume ratio), LiPF₆ as a solute so as to adjust the concentration of LiPF₆ to 1.0 mol/liter.

Fabrication of battery: A wound electrode plate was prepared by laminating the above polyolefin microporous membrane, a strip positive electrode, and a strip negative electrode in the order of the strip negative electrode, the separator, the strip positive electrode, and the separator, winding the resulting laminate a plurality of times into a spiral and stopping winding with a PP adhesive tape having a thickness of 20 μm. When the membrane that was embossed or pressed with a plain roll was used, they were laminated so that the surface that was pressed by the roll 1 which will be described later came into contact with the active material of the negative electrode strip. The wound electrode plate was housed in an aluminum container having an outer diameter of 18 mm and a height of 65 mm and a nickel tab introduced from the positive electrode current collector was welded with the wall of the container and the nickel tab introduced from the negative electrode current collector was welded with a lid terminal portion of the container. Then, drying was performed at 85° C. for 12 hours under vacuum. The above described nonaqueous electrolyte solution was then injected into the container in an argon box, followed by sealing.

In Examples 1 to 23, the length of each of the polyolefin microporous membrane, strip positive electrode, and strip negative electrode was adjusted to give an initial discharge capacity of 1500 mAh.

Charging/discharging treatment: Initial charging/discharging of the battery thus fabricated was performed by constant-current charging at a current rate of ⅙C to 4.2V and starting to reduce the current to keep a constant voltage of 4.2V, thereby carrying out initial charging for 8 hours in total; and then, discharging at a current rate of ⅙C to a final voltage of 2.5V. Then, as cycle charging/discharging, charging/discharging was performed 50 times in total under the following cycle conditions: [1] constant-current constant-voltage charging for 8 hours in total at a current rate of 0.5C and an upper-limit voltage of 4.2V, [2] non-operation time for 10 minutes, [3] constant-current discharging at a current rate of 0.5C to final voltage of 2.5V, and [4] non-operation time for 10 minutes. The above charging/discharging operations were all performed in an atmosphere of 25° C. Then, a capacity retention ratio (%) was determined by multiplying a ratio of the discharged capacity on cycle 50 to the discharged capacity at the initial charging by 100.

### (10) Evaluation of Electrolyte Retention Condition

The battery was disassembled after cycle charging/discharging 50 times and the electrolyte retention condition was observed visually. Based on the observation, the condition was evaluated good or bad.

### (11) Initial Discharge Capacity.

In the above evaluation (10) of the electrolyte retention condition, a discharge capacity at the time of initial charging/discharging was measured and determined to be an initial discharge capacity.

### (12) Diameter of Wound Electrode Plate

Diameters at any three points in the length direction of the wound electrode plate prepared in the evaluation (9) of battery performance were measured with a caliper square and an average of them was determined to be the diameter of the wound electrode plate.

### EXAMPLES

The present invention will hereinafter be described based on Examples. In embossing in the following Examples and Comparative Examples, an engraved embossing roll manufactured by Yuri Roll Machine Co., Ltd. was used as an embossing roll and a line rate when a gel sheet or film was passed between embossing rolls or plain rolls was set at 1 m/min unless otherwise specifically indicated.

### Example 1

In a tumbler blender, 95 wt. % of a polyethylene homopolymer having Mv of 250000 and 5 wt. % of a polypropylene homopolymer having Mv of 400000 were dry blended. To 99 wt. % of the pure polymer mixture thus obtained was added 1 wt. % of pentaerythrityl-tetrakis-[3-(3,5-di-t-butyl-4-hydroxyphenyl)propionate] as an antioxidant, followed by dry-blending in the tumbler blender again to obtain a polymer-containing mixture. After the atmosphere was substituted with nitrogen, the polymer-containing mixture thus obtained was supplied to a twin-screw extruder in a nitrogen atmosphere by using a feeder. Liquid paraffin (having a viscoelasticity of 7.59×10⁻⁵ m²/s at 37.78° C.) was injected into the cylinder of the extruder via a plunger pump. The first peak available at 10° C./min by the DSC method, that is, a melting point of the pure polymer mixture, was 137.2° C.

The feeder and the pump were adjusted so that a liquid paraffin amount ratio in the total mixture to be extruded after melting and kneading became 55 wt. %. The melting and kneading were performed under the conditions of a preset temperature of 200° C., a screw rotation speed of 240 rpm, and a discharge rate of 12 kg/h.

The kneaded melt was then extruded and cast through a T-die onto a cooling roll controlled to a surface temperature of 25° C., whereby a gel sheet having a thickness of 2000 μm was obtained.

The gel sheet was then passed between two rolls, that is, an embossing roll (roll 1) and a backup roll (roll 2) and was embossed while adjusting a linear pressure between the rolls to 110 N/mm. The roll 1 had an outer diameter of 100 mm and an embossed pattern of diagonal lattices with a density of 25 meshes/inch) and a depth of 0.225 mm. Its surface temperature was adjusted to 70° C. The roll 2 had an outer diameter of 200 mm and a plain surface. Its surface temperature was adjusted to room temperature.

The embossed gel sheet was then introduced into a simultaneous biaxial tenter stretching machine and biaxially stretched. The stretching was performed under the conditions of an MD draw magnification of 7.0, a TD draw magnification of 6.4 and a preset temperature of 118° C.

The resulting gel sheet was introduced into a methyl ethyl ketone tank. It was immersed completely in methyl ethyl ketone to remove the liquid paraffin by extraction. Then, the methyl ethyl ketone was removed by drying.

The sheet was then placed on a TD tenter and thermally fixed. The thermal fixing temperature was set at 125° C. and a TD relaxation ratio was set at 0.80.

With regard to the polyolefin microporous membrane thus obtained, various physical properties, battery performance, and electrolyte retention condition were evaluated and the results are shown in Table 1.

### Example 2

In a tumbler blender, 47.5 wt. % of a polyethylene homopolymer having Mv of 700000, 47.5 wt. % of a polyethylene homopolymer having Mv of 250000, and 5 wt. % of a polypropylene homopolymer having Mv of 400000 were dry blended. To 99 wt. % of the pure polymer mixture thus obtained was added 1 wt. % of pentaerythrityl-tetrakis-[3-(3,5-di-t-butyl-4-hydroxyphenyl)propionate] as an antioxidant, followed by dry blending in the tumbler blender again to obtain a polymer-containing mixture. After the atmosphere was substituted with nitrogen, the obtained polymer-containing mixture was supplied to a twin-screw extruder in a nitrogen atmosphere by using a feeder. Liquid paraffin (having a viscoelasticity of 7.59×10⁻⁵ m²/s at 37.78° C.) was injected into the cylinder of the extruder via a plunger pump.

The feeder and the pump were adjusted so that a liquid paraffin amount ratio in the total mixture to be extruded after melting and kneading became 65 wt. %. The melting and kneading were performed under the conditions of a preset temperature of 200° C., a screw rotation speed of 240 rpm, and a discharge rate of 12 kg/h.

The kneaded melt was then extruded and cast through a T-die onto a cooling roll controlled to a surface temperature of 25° C., whereby a gel sheet having a thickness of 1300 μm was obtained.

The gel sheet was passed between two rolls, that is, an embossing roll (roll 1) and a backup roll (roll 2) and was embossed while adjusting a linear pressure between the rolls to 100 N/mm. The roll 1 had an outer diameter of 100 mm and an embossed pattern of diagonal lattices with a density of 54 meshes/inch and a depth of 0.16 mm. Its surface temperature was adjusted to 100° C. The roll 2 had an outer diameter of 200 mm and a plain surface. Its surface temperature was adjusted to room temperature.

The resulting embossed sheet was then introduced into a simultaneous biaxial tenter stretching machine and biaxially stretched. The stretching was performed under the conditions of an MD draw magnification of 7.0, a TD draw magnification of 6.4 and a preset temperature of 120° C.

The stretched gel sheet was then introduced into a methyl ethyl ketone tank. It was immersed completely in methyl ethyl ketone to remove the liquid paraffin by extraction. Then, the methyl ethyl ketone was removed by drying.

The sheet was then placed on a TD tenter and thermally fixed. The thermal fixing temperature was set at 125° C. and a TD relaxation ratio was set at 0.80.

With regard to the polyolefin microporous membrane thus obtained, various physical properties, battery performance, and electrolyte retention condition were evaluated and the results are shown in Table 1.

### Example 3

In the same manner as in Example 2 except that after the kneaded melt was extruded onto a cooling roll, the extrudate was cast by bank formation method, embossing was carried out under the following conditions, a biaxial orientation temperature was 118° C. and a thermal fixing temperature was 122° C. a polyolefin microporous membrane was prepared.

In the present example, the gel sheet was passed between two embossing rolls (roll 1 and roll 2) while adjusting a linear pressure between the rolls to 110 N/mm. The roll 1 and the roll 2 had each an outer diameter of 100 mm and an embossed pattern of diagonal lattices with a density of 64 meshes/inch and a depth of 0.102 mm. Their surface temperature was adjusted to 85° C.

With regard to the polyolefin microporous membrane thus obtained, various physical properties, battery performance, and electrolyte retention condition were evaluated and the evaluation results are shown in Table 1, while observation results of the shape of protrusions are shown in FIG. 1.

In the present example, a battery was fabricated by laminating the membrane and a negative electrode stripe so that the surface of the membrane on which the protrusions were formed with the roll 1 come into contact with the active material of the negative electrode strip.

### Example 4

In a tumbler blender, 47.5 wt. % of a polyethylene homopolymer having Mv of 700000, 47.5 wt. % of a polyethylene homopolymer having Mv of 250000, and 5 wt. % of a polypropylene homopolymer having Mv of 400000 were dry blended. To 99 wt. % of the pure polymer mixture thus obtained was added 1 wt. % of pentaerythrityl-tetrakis-[3-(3,5-di-t-butyl-4-hydroxyphenyl)propionate] as an antioxidant, followed by dry blending in the tumbler blender again to obtain a polymer-containing mixture. After the atmosphere was substituted with nitrogen, the obtained polymer-containing mixture was supplied to a twin-screw extruder in a nitrogen atmosphere by using a feeder. Liquid paraffin (having a viscoelasticity of 7.59×10⁻⁵ m²/s at 37.78° C.) was injected into the cylinder of the extruder via a plunger pump.

The feeder and the pump were adjusted so that a liquid paraffin amount ratio in the total mixture to be extruded after melting and kneading became 65 wt. %. The melting and kneading were performed under the conditions of a preset temperature of 200° C., a screw rotation speed of 240 rpm, and a discharge rate of 12 kg/h.

The kneaded melt was then extruded through a T-die, passed between two rolls, that is, an embossing roll (roll 1) and a backup roll (roll 2) and embossed while adjusting a linear pressure between the rolls to 90 N/mm. The roll 1 had an outer diameter of 100 mm and an embossed pattern of diagonal lattices as with a density of 64 meshes/inch, and a depth of 0.102 mm. Its surface temperature was adjusted to 110° C. The roll 2 had an outer diameter of 200 mm and a plain surface. Its surface temperature was adjusted to 110° C. By casting onto a cooling roll controlled to a surface temperature of 27° C., a gel sheet having a thickness of 1300 μm including the height of emboss was obtained.

The embossed gel sheet was then introduced into a simultaneous biaxial tenter stretching machine and biaxially stretched. The stretching was performed under the conditions of an MD draw magnification of 7.0, a TD draw magnification of 6.4 and a preset temperature of 120° C.

The resulting gel sheet was then introduced into a methyl ethyl ketone tank. It was immersed completely in methyl ethyl ketone to remove the liquid paraffin by extraction. Then, the methyl ethyl ketone was removed by drying.

The sheet was then placed on a TD tenter and thermally fixed. The thermal fixing temperature was set at 125° C. and a TD relaxation ratio was set at 0.80.

With regard to the polyolefin microporous membrane thus obtained, various physical properties, battery performance, and electrolyte retention condition were evaluated and the results are shown in Table 1.

### Example 5

In a tumbler blender, 20 wt. % of a polyethylene homopolymer having Mv of 2500000, 15 wt. % of a polyethylene homopolymer having Mv of 700000, wt. % of a polyethylene homopolymer having Mv of 250000, and 30 wt. % of an ethylene propylene copolymer (comonomer: propylene, content: 0.6 mol. %) having Mv of 120000 were dry blended. To 99 wt. % of the pure polymer mixture thus obtained was added 1 wt. % of pentaerythrityl-tetrakis-[3-(3,5-di-t-butyl-4-hydroxyphenyl)propionate] as an antioxidant, followed by dry-blending in the tumbler blender again to obtain a polymer-containing mixture. The atmosphere was substituted with nitrogen and the polymer-containing mixture thus obtained was then supplied to a twin-screw extruder in a nitrogen atmosphere by using a feeder. Liquid paraffin (having a viscoelasticity of 7.59×10⁻⁵ m²/s at 37.78° C.) was injected into the cylinder of the extruder via a plunger pump. The feeder and the pump were adjusted so that a liquid paraffin amount ratio in the total mixture to be extruded after melting and kneading became 65 wt. %. The melting and kneading were performed under the conditions of a preset temperature of 200° C., a screw rotation speed of 240 rpm, and a discharge rate of 12 kg/h.

The kneaded melt was then extruded and cast through a T-die onto a cooling roll controlled to a surface temperature of 25° C., whereby a gel sheet having a thickness of 1800 μm was obtained.

The gel sheet was passed between two rolls, that is, an embossing roll (roll 1) and a backup roll (roll 2) and was embossed while adjusting a linear pressure between the rolls to 120 N/mm. The roll 1 had an outer diameter of 100 mm, and an embossed pattern of diamond patterns with a density of 400 meshes/inch, and a depth of 1.2 mm. Its surface temperature was adjusted to 95° C. The roll 2 had an outer diameter of 200 mm and a plain surface. Its surface temperature was adjusted to room temperature.

The resulting sheet was then introduced into a simultaneous biaxial tenter stretching machine and biaxially stretched. The stretching was performed under the conditions of an MD draw magnification of 7.0, a TD draw magnification of 6.4 and a preset temperature of 120° C.

The sheet was then introduced into a methyl ethyl ketone tank. It was immersed completely in methyl ethyl ketone to remove the liquid paraffin by extraction. Then, the methyl ethyl ketone was removed by drying.

The sheet was then placed on a TD tenter and thermally fixed. The thermal fixing temperature was set at 120° C. and a TD relaxation ratio was set at 0.75.

With regard to the polyolefin microporous membrane thus obtained, various physical properties, battery performance, and electrolyte retention condition were evaluated and the results are shown in Table 1.

### Example 6

In a tumbler blender, 20 wt. % of a polyethylene homopolymer having Mv of 2500000, 15 wt. % of a polyethylene homopolymer having Mv of 700000, wt. % of a polyethylene homopolymer having Mv of 250000, and 30 wt. % of an ethylene propylene copolymer (comonomer: propylene, content: 0.6 mol. %) having MV of 120000 were dry blended. To 99 wt. % of the pure polymer mixture thus obtained was added 1 wt. % of pentaerythrityl-tetrakis-[3-(3,5-di-t-butyl-4-hydroxyphenyl)propionate] as an antioxidant, followed by dry-blending in the tumbler blender again to obtain a polymer-containing mixture. After the atmosphere was substituted with nitrogen, the polymer containing mixture thus obtained was supplied via a feeder to a twin-screw extruder in a nitrogen atmosphere. Liquid paraffin (having a viscoelasticity of 7.59×10⁻⁵ m²/s at 37.78° C.) was injected into the cylinder of the extruder via a plunger pump.

The feeder and the pump were adjusted so that a liquid paraffin amount ratio in the total mixture to be extruded after melting and kneading became 65 wt. %. The melting and kneading were performed under the conditions of a preset temperature of 200° C., a screw rotation speed of 240 rpm, and a discharge rate of 12 kg/h.

The kneaded melt was then extruded and cast through a T-die onto a cooling roll controlled to a surface temperature of 25° C., whereby a gel sheet having a thickness of 800 μm was obtained.

The gel sheet was then passed between two embossing rolls (roll 1 and roll 2) and was embossed while adjusting a linear pressure between the rolls to 110 N/mm. The roll 1 had an outer diameter of 100 mm, and an embossed pattern of diagonal lattice with a density of 25 meshes/inch and a depth of 0.225 mm. Its surface temperature was adjusted to 75° C. The roll 2 had an outer diameter of 100 mm, and an embossed pattern of diamond patterns with a density of 300 meshes/inch and a depth of 0.03 mm. Its surface temperature was adjusted to 75° C.

The resulting sheet was then introduced into a simultaneous biaxial tenter stretching machine and biaxially stretched. The stretching was performed under the conditions of an MD draw magnification of 7.0, a TD draw magnification of 6.4 and a preset temperature of 118° C. The sheet was then introduced into a methyl ethyl ketone tank. It was immersed completely in methyl ethyl ketone to remove the liquid paraffin by extraction. Then, the methyl ethyl ketone was removed by drying.

The sheet was then placed on a TD tenter and it was thermally fixed. The thermal fixing temperature was set at 120° C. and a TD relaxation ratio was set at 0.80.

With regard to the polyolefin microporous membrane thus obtained, various physical properties, battery performance, and electrolyte retention condition were evaluated and the results are shown in Table 1.

In the present example, a battery was fabricated by laminating the membrane and a negative electrode stripe so that the surface of the membrane on which the protrusions were formed with the roll 1 come into contact with the active material of the negative electrode strip.

### Example 7

In a tumbler blender, 20 wt. % of a polyethylene homopolymer having Mv of 2500000, 15 wt. % of a polyethylene homopolymer having Mv of 700000, wt. % of a polyethylene homopolymer having Mv of 250000, and 30 wt. % of an ethylene propylene copolymer (comonomer: propylene, content: 0.6 mol. %) having Mv of 120000 were dry blended. To 99 wt. % of the pure polymer mixture thus obtained was added 1 wt. % of pentaerythrityl-tetrakis-[3-(3,5-di-t-butyl-4-hydroxyphenyl)propionate] as an antioxidant, followed by dry blending in the tumbler blender again to obtain a polymer-containing mixture. After the atmosphere was substituted with nitrogen, the polymer containing mixture thus obtained was supplied to a twin-screw extruder in a nitrogen atmosphere by using a feeder. Liquid paraffin (having a viscoelasticity of 7.59×10⁻⁵ m²/s at 37.78° C.) was injected into the cylinder of the extruder via a plunger pump.

The feeder and the pump were adjusted so that a liquid paraffin amount ratio in the total mixture to be extruded after melting and kneading became 65 wt. %. The melting and kneading were performed under the conditions of a preset temperature of 200° C., a screw rotation speed of 240 rpm, and a discharge rate of 12 kg/h.

The kneaded melt was then extruded and cast through a T-die onto a cooling roll controlled to a surface temperature of 25° C., whereby a gel sheet having a thickness of 1200 μm was obtained.

The gel sheet was passed between an embossing roll (roll 1) and a backup roll (roll 2) and was embossed while adjusting a linear pressure between the rolls to 115 N/mm. The roll 1 had an outer diameter of 100 mm, and an embossed pattern of diagonal lattice with a density of 100 meshes/inch and a depth of 0.107 mm. Its surface temperature was adjusted to 95° C. The roll 2 had an outer diameter of 200 mm and a plain surface. Its surface temperature was adjusted to room temperature.

The resulting sheet was then introduced into a simultaneous biaxial tenter stretching machine and biaxially stretched. The stretching was performed under the conditions of an MD draw magnification of 7.0, a TD draw magnification of 6.4 and a preset temperature of 118° C.

The stretched gel sheet was then introduced into a methyl ethyl ketone tank. It was immersed completely in methyl ethyl ketone to remove the liquid paraffin by extraction. Then, the methyl ethyl ketone was removed by drying.

The sheet was then placed on a TD tenter and thermally fixed. The thermal fixing temperature was set at 115° C. and a TD relaxation ratio was set at 0.80.

With regard to the polyolefin microporous membrane thus obtained, various physical properties, battery performance, and electrolyte retention condition were evaluated and the results are shown in Table 1.

### Example 8

In the same manner as in Example 6 except that the thickness of the sheet obtained by casting was adjusted to 950 μm; embossing was performed under the following conditions; a biaxial stretching was performed at a 7×5 draw magnification; and a biaxial stretching temperature was changed to 117° C., a polyolefin microporous membrane was obtained.

The embossing was performed in the present example by passing the gel sheet between an embossing roll (roll 1) and a backup roll (roll 2) while adjusting a linear pressure between the rolls to 95 N/mm. The roll 1 had an outer diameter of 100 mm and an embossed pattern of diamond with a density of 300 meshes/inch and a depth of 0.03 mm. Its surface temperature was adjusted to 70° C. The roll 2 had an outer diameter of 200 mm and a plain surface. Its surface temperature was adjusted to room temperature.

With regard to the polyolefin microporous membrane thus obtained, various physical properties, battery performance, and electrolyte retention condition were evaluated and the results are shown in Table 1.

### Example 9

To 30 wt. % of a PE having Mv of 2000000 and 70 wt. % of a high-density PE having Mv of 300000 was added 1 wt. % of pentaerythrityl-tetrakis-[3-(3,5-di-t-butyl-4-hydroxyphenyl)propionate] as an antioxidant and the resulting mixture was dry blended in a tumbler blender to obtain a polymer-containing mixture. After the atmosphere was substituted with nitrogen, the polymer containing mixture thus obtained was supplied to a twin-screw extruder in a nitrogen atmosphere by using a feeder. Liquid paraffin (having a viscoelasticity of 7.59×10⁻⁵ m²/s at 37.78° C.) was injected into the cylinder of the extruder via a plunger pump.

The feeder and the pump were adjusted so that a liquid paraffin amount ratio in the total mixture to be extruded after melting and kneading became 80 wt. %. The melting and kneading were performed under the conditions of a preset temperature of 200° C., a screw rotation speed of 200 rpm, and a discharge rate of 12 kg/h.

The kneaded melt was then extruded and cast through a T-die onto a cooling roll controlled to a surface temperature of 30° C., whereby a gel sheet having a thickness of 1800 μm was obtained.

The gel sheet was passed between an embossing roll (roll 1) and a backup roll (roll 2) and was embossed while adjusting a linear pressure between the two rolls to 95 N/mm. The roll 1 had an outer diameter of 100 mm and an embossed pattern of diagonal lattice with 100 a density of meshes/inch and a depth of 0.107 mm. Its surface temperature was adjusted to 82° C. The roll 2 had an outer diameter of 200 mm and a plain surface. Its surface temperature was adjusted to room temperature.

The resulting sheet was then introduced into a simultaneous biaxial tenter stretching machine and biaxially stretched. The stretching was performed under the conditions of an MD draw magnification of 7.0, a TD draw magnification of 7.0 and a preset temperature of 105° C.

The sheet was then introduced into a methyl ethyl ketone tank. It was immersed completely in methyl ethyl ketone to remove the liquid paraffin by extraction. Then, the methyl ethyl ketone was removed by drying.

The sheet was then stretched at a draw magnification of 1.4 in MD at 115° C. It was then placed onto a TD tenter and stretched at a draw magnification of 2.0 in TD at 115° C. A relaxation treatment was then performed using the tenter at 110° C. for 10 seconds to adjust the MD size and the TD size of the membrane to 95% and 95% of those immediately before relaxation, respectively. It was then thermally fixed for 15 minutes at 120° C. by using the tenter.

With regard to the polyolefin microporous membrane thus obtained, various physical properties, battery performance, and electrolyte retention condition were evaluated and the results are shown in Table 1.

### Example 10

To 30 wt. % of a PE having Mv of 2000000 and 70 wt. % of a high-density PE having Mv of 300000 was added 1 wt. % of pentaerythrityl-tetrakis-[3-(3,5-di-t-butyl-4-hydroxyphenyl)propionate] as an antioxidant and the resulting mixture was dry blended in a tumbler blender to obtain a polymer-containing mixture. After the atmosphere was substituted with nitrogen, the polymer containing mixture thus obtained was supplied to a twin-screw extruder in a nitrogen atmosphere by using a feeder. Liquid paraffin (having a viscoelasticity of 7.59×10⁻⁵ m²/s at 37.78° C.) was injected into the cylinder of the extruder via a plunger pump.

The feeder and the pump were adjusted so that a liquid paraffin amount ratio in the total mixture to be extruded after melting and kneading became 80 wt. %. The melting and kneading were performed under the conditions of a preset temperature of 200° C., a screw rotation speed of 200 rpm, and a discharge rate of 12 kg/h.

The kneaded melt was then extruded through a T-die and cool-cast by passing it between an embossing roll (roll 1) and a backup roll (roll 2) to obtain a gel sheet, while embossing it. The roll 1 had an outer diameter of 100 mm and an embossed pattern of diagonal lattice with a density of 100 meshes/inch and a depth of 0.107 mm. Its surface temperature was adjusted to 30° C. The roll 2 had an outer diameter of 200 mm and a plain surface. Its surface temperature was adjusted to 30° C. The linear pressure between the two rolls and the thickness of the gel sheet including the height of emboss were adjusted to 90 N/mm and 1800 μm, respectively.

The embossed gel sheet was then introduced into a simultaneous biaxial tenter stretching machine and biaxially stretched. The stretching was performed under the conditions of an MD draw magnification of 7.0, a TD draw magnification of 7.0 and a preset temperature of 105° C.

The resulting sheet was then introduced into a methyl ethyl ketone tank. It was immersed completely in methyl ethyl ketone to remove the liquid paraffin by extraction. Then, the methyl ethyl ketone was removed by drying.

The membrane thus obtained was then stretched at a draw magnification of 1.4 in MD at 115° C. by using a roll stretching machine. It was then introduced onto a TD tenter and stretched at a draw magnification of 2.0 in TD at 115° C. A relaxation treatment was then performed on the tenter at 110° C. for 10 seconds to adjust the MD size and the TD size of the membrane to 95% and 95% of those immediately before the relaxation treatment, respectively. It was then thermally fixed for 15 minutes at 120° C. by using the tenter.

With regard to the polyolefin microporous membrane thus obtained, various physical properties, battery performance, and electrolyte retention condition were evaluated and the results are shown in Table 1.

### Example 11

To 30 wt. % of a PE having Mv of 2000000 and 70 wt. % of a high-density PE having Mv of 300000 was added 1 wt. % of pentaerythrityl-tetrakis-[3-(3,5-di-t-butyl-4-hydroxyphenyl)propionate] as an antioxidant and the resulting mixture was dry blended in a tumbler blender to obtain a polymer-containing mixture. After the atmosphere was substituted with nitrogen, the polymer containing mixture thus obtained was supplied to a twin-screw extruder in a nitrogen atmosphere by using a feeder. Liquid paraffin (having a viscoelasticity of 7.59×10⁻⁵ m²/s at 37.78° C.) was injected into the cylinder of the extruder via a plunger pump.

The feeder and the pump were adjusted so that a liquid paraffin amount ratio in the total mixture to be extruded after melting and kneading became 80 wt. %. The melting and kneading were performed under the conditions of a preset temperature of 200° C., a screw rotation speed of 200 rpm, and a discharge rate of 12 kg/h.

The kneaded melt was then extruded and cast through a T-die onto a cooling roll adjusted to have a surface temperature of 30° C. to obtain a gel sheet having a thickness of 1800 μm.

The gel sheet was then passed between an embossing roll (roll 1) and a backup roll (roll 3) and embossed while adjusting the linear pressure between these two rolls at 105 Nm/mm. The roll 1 had an outer diameter of 100 mm, and an embossed pattern of diagonal lattice with a density of 54 meshes/inch and a depth of 0.16 mm. Its surface temperature was adjusted to 100° C. The roll 3 had an outer diameter of 200 mm and a plain surface. Its surface temperature was adjusted to room temperature.

The resulting sheet was then introduced into a simultaneous biaxial tenter stretching machine and biaxially stretched. The stretching was performed under the conditions of an MD draw magnification of 7.0, a TD draw magnification of 7.0 and a preset temperature of 105° C.

The gel sheet was then introduced into a methyl ethyl ketone tank. It was immersed completely in methyl ethyl ketone to remove the liquid paraffin by extraction. Then, the methyl ethyl ketone was removed by drying to obtain a membrane.

Another surface of the resulting membrane which had not been embossed yet was embossed. Described specifically, the membrane was passed through an embossing roll (roll 2) and a backup roll (roll 4) and embossed while adjusting the linear pressure between the rolls at 70 N/mm. The roll 2 had an outer diameter of 100 mm and an embossed pattern of diamond with a density of 300 meshes/inch and a depth of 0.03 mm. Its surface temperature was adjusted to 115° C. The roll 2 had an outer diameter of 200 mm and a plain surface. Its surface temperature was adjusted to room temperature.

In the above embossing, the roll 1 and the roll 2 were placed to enable embossing different surfaces of one membrane. The membrane thus obtained was then stretched at a draw magnification of 1.4 in MD at 115° C. by using a roll stretching machine. It was then introduced onto a TD tenter and stretched at a draw magnification of 2.0 in TD at 115° C. Relaxation treatment was then performed on the tenter at 110° C. for 10 seconds to adjust the MD size and the TD size of the membrane to 95% and 95% of those immediately before the relaxation treatment, respectively. It was then thermally fixed for 15 minutes at 120° C. by using the tenter.

With regard to the polyolefin microporous membrane thus obtained, various physical properties, battery performance, and electrolyte retention condition were evaluated and the results are shown in Table 1.

In the present example, a battery was fabricated by laminating the membrane and a negative electrode stripe so that the surface of the membrane on which the protrusions were formed with the roll 2 come into contact with the active material of the negative electrode strip.

### Comparative Example 1

In the same manner as in Example 1 except that the gel sheet obtained by casting was introduced into the simultaneous biaxial tenter stretching machine without embossing, a polyolefin microporous membrane was obtained.

With regard to the polyolefin microporous membrane thus obtained, various physical properties, battery performance, and electrolyte retention condition were evaluated and the results are shown in Table 1.

### Comparative Example 2

In the same manner as in Example 1 except that the gel sheet was not embossed but pressed, as described below, with a roll having a plain surface, a microporous membrane was obtained.

In the present comparative example, the gel sheet was passed between two plain rolls (roll 1 and roll 2) while adjusting the linear pressure between the rolls at 115 N/mm. The rolls 1 and 2 had each an outer diameter of 100 mm and a plain surface. Their surface temperature was adjusted to 70° C.

With regard to the polyolefin microporous membrane thus obtained, various physical properties, battery performance, and electrolyte retention condition were evaluated and the results are shown in Table 1.

### Comparative Example 3

In the same manner as in Example 1 except embossing was performed under the following conditions, a porous membrane was obtained.

The embossing in the present comparative example was performed by passing the gel sheet between an embossing roll (roll 1) and a backup roll (roll 2) while adjusting the linear pressure between these rolls to 115 N/mm. The roll 1 had an outer diameter of 100 mm and a embossed pattern of honeycomb pattern with a density of 2 meshes/inch and a depth of 0.45 mm. Its surface temperature was adjusted to 70° C. The roll 2 had an outer diameter of 200 mm and had a plain surface. Its surface temperature was adjusted to a room temperature.

With regard to the polyolefin microporous membrane thus obtained, various physical properties, battery performance, and electrolyte retention condition were evaluated and the results are shown in Table 1.

### Example 12

In the same manner as in Example 1 except that the liquid paraffin amount ratio was changed to 50 wt. %, the thickness of the gel sheet was changed to 2280 μm, and density and depth of the embossed pattern of the roll 1 were changed to 100 meshes/inch and 0.107 mm, respectively, a polyolefin microporous membrane was obtained.

### Example 13

In the same manner as in Example 5 except that the thickness of the gel sheet was changed to 2200 μm and the depth of the embossed pattern of the roll 1 was changed to 1.5 mm, a polyolefin microporous membrane was obtained.

### Example 14

After 19.2 wt. % of a ultra-high-molecular weight polyethylene having an intrinsic viscosity [η] (an intrinsic viscosity at 135° C. using a decalin solvent in accordance with ASTM D4020) of 7.0 dl/g, 12.8 wt. % of a high density polyethylene having [η] of 2.8 dl/g, 48 wt. % of dioctyl phthalate (DOP), and 20 wt. % of powdery silica were mixed and granulated and then, melted and kneaded in a twin-screw extruder equipped, at the end portion thereof, with a T die, the kneaded melt was extruded and extended with heated rolls placed on both sides thereof to obtain a sheet having a thickness of 90 μm. The first peak as measured by DSC at 10° C./min, that is, the melting point, of a polyolefin resin mixture composed of 19.2 wt. % of the ultra-high-molecular weight polyethylene having an intrinsic viscosity [h] of 7.0 dl/g and 12.8 wt. % of the high density polyethylene having [h] of 2.8 dl/g was 140° C.

Next, the DOP and powdery silica were removed by extraction from the sheet to obtain a film (unprocessed film).

The film was passed between an embossing roll (roll 1) and a backup roll (roll 2) at a line speed of 10 m/min and embossed while controlling the pressure applied between the rolls to 1.0 ton to obtain an embossed film (processed film). The roll 1 had an outer diameter of 100 mm, and an embossed pattern of diagonal lattice with a density of 100 meshes/inch and a depth of 0.107 mm. Its surface temperature was controlled to 50° C. The roll 2 had an outer diameter of 200 mm and a plain surface. Its surface temperature was adjusted to room temperature.

The processed film and the unprocessed film were stacked so that the embossed surface of the processed film came on the obverse side. After the stack was stretched at a draw magnification of 5 in MD by using a roll stretching machine (the temperature of the roll on the side coming into contact with the processed film was set at 70° C., while the temperature of the roll on the side coming into contact with the unprocessed film was set at 120° C.), it was stretched at a draw magnification of 2.0 in TD at 120° C. with a tenter and stretched further at a draw magnification of 1.8 at 140° C., followed by heat treatment, whereby a polyolefin microporous membrane was obtained.

### Example 15

In the same manner as in Example 14, a sheet having a thickness of 89 μm was obtained and from the sheet, the DOP and powdery silica were removed by extraction to obtain an unprocessed film.

Then, the resulting film was passed between an embossing roll (roll 1) and a backup roll (roll 2) at a line speed of 20 m/min and embossed while controlling the pressure applied between the two rolls to 0.95 ton to obtain an embossed film (processed film). The roll 1 had an outer diameter of 100 mm and an embossed pattern of diagonal lattices with a density of 200 meshes/inch and a depth of 0.042 mm. Its surface temperature was controlled to 50° C. The roll 2 had an outer diameter of 200 mm and a plain surface. Its surface temperature was adjusted to room temperature.

The two processed films were stacked so that that the embossed surfaces of the processed films came on the obverse side. After the stack was stretched at a draw magnification of 5 in MD by using a roll stretching machine (the temperatures of the rolls were alternately set at 72° C. and 120° C.), it was stretched at a draw magnification of 2.2 in TD at 120° C. with a tenter and then, stretched at a draw magnification of 2.0 at 140° C., followed by heat treatment to obtain a polyolefin microporous membrane.

### Example 16

In the same manner as in Example 14, a sheet having a thickness of 90 μm was obtained and from the sheet, the DOP and powdery silica were removed by extraction to obtain an unprocessed film.

The resulting film was passed between an embossing roll (roll 1) and a backup roll (roll 2) at a line speed of 10 m/min and was embossed while controlling the pressure applied between the rolls to 1.0 ton to obtain an embossed film (processed film). The roll 1 had an outer diameter of 100 mm and an embossed pattern of diagonal lattice with a density of 200 meshes/inch and a depth of 0.042 mm. Its surface temperature was controlled to 50° C. The roll 2 had an outer diameter of 200 mm and a plain surface. Its surface temperature was adjusted to room temperature.

After the processed film was stretched at a draw magnification of 2.5 in MD by using a roll stretching machine (the roll coming into contact with the embossed surface of the processed film was set at 68° C., while the roll coming into contact with the unprocessed film was set at 120° C.), it was stretched at a draw magnification of 2.1 in TD at 120° C. with a tenter and then, stretched at a draw magnification of 1.8 at 132° C., followed by heat treatment to obtain a polyolefin microporous membrane.

### Example 17

In the same manner as in Example 14, a sheet having a thickness of 150 μm was obtained and from the sheet, the DOP and powdery silica were removed by extraction to obtain an unprocessed film.

The resulting film was passed between an embossing roll (roll 1) and a backup roll (roll 2) at a line speed of 5 m/min and embossed while controlling the pressure applied between the rolls to 1.0 ton to obtain an embossed film (processed film). The roll 1 had an outer diameter of 100 mm, and an embossed pattern of diagonal lattice with a density of 100 meshes/inch and a depth of 0.107 mm. Its surface temperature was controlled to 65° C. The roll 2 had an outer diameter of 200 mm and a plain surface. Its surface temperature was adjusted to room temperature.

After the processed film was stretched at a draw magnification of 1.5 in MD by using a roll stretching machine (the roll coming into contact with the embossed surface of the processed film was set at 65° C., while the roll coming into contact with the unprocessed film was set at 120° C.), it was stretched at a draw magnification of 2.0 in TD at 120° C. with a tenter and then, stretched at a draw magnification of 1.8 at 134° C., followed by heat treatment to obtain a polyolefin microporous membrane.

### Example 18

### An Alloy Negative Electrode Prepared by Plating was Used as a Negative Electrode

In the same manner as in Example 1 except that the polyolefin microporous membrane as described in Example 1 was used and a negative electrode prepared by the following manner was used, battery performance and electrolyte retention condition were evaluated.

In the present example, the negative electrode was prepared in the following manner. Described specifically, an electrolytic copper foil having a thickness of 11 μm was degreased for 1 minute in an alkali electrolytic degreasing solution of room temperature at a current density of 0.01 A/cm² and washed with water. After acid washing with an aqueous sulfuric acid solution having a concentration of 10%, the foil was washed with water. A Sn—Zn alloy film having a Zn content of 10 wt. % was then precipitated on both sides of an electrolytic copper foil by electroplating in a Sn—Zn plating bath, which will be described later, for 10 minutes and then, heat treated for 5 hours under vacuum at 220° C. to obtain a negative electrode. The resulting negative electrode was cut into strips having a width of 56 mm. For the Sn—Zn plating bath, a solution obtained by dissolving 280 g/L of tin methanesulfonate, 15 g/L of zinc sulfate heptahydrate, 200 g of trisodium citrate dihydrate, 130 g of ammonium sulfate, and 1 gl/L of sodium L-ascorbate in distilled water and adjusting the pH to 5 was used.

### Example 19

### A Carbon Negative Electrode was Used as a Negative Electrode

In the same manner as in Example 1 except that the polyolefin microporous membrane described in Example 1 was used and a negative electrode prepared by the following manner was used, battery performance and electrolyte retention condition were evaluated.

In the present example, the negative electrode was prepared in the following manner. Described specifically, a slurry was prepared by dispersing, in purified water, 96.9 wt. % of artificial graphite as an active material, 1.4 wt. % of an ammonium salt of carboxymethyl cellulose as a binder, and 1.7 wt. % of a styrene-butadiene copolymer latex. The resulting slurry was coated onto both surfaces of a copper foil having a thickness of 12 μm, which will be a negative electrode current collector, by using a die coater. After drying at 120° C. for 3 minutes, the resulting copper foil was compression molded with a roll press. On each surface, the coating weight of the active material of the negative electrode and the bulk density of the active material were adjusted to 106 g/m² and 1.35 g/cm³, respectively. The resulting copper foil was cut into strips each having a width of about 56 mm.

### Example 20

After obtaining a gel sheet in the same manner as in Example 1, it was biaxially stretched under similar conditions to Example 1 without embossing it to obtain a film having a thickness of 38 μm.

The resulting film was then passed between an embossing roll (roll 1) and a backup roll (roll 2) and was embossed while adjusting the linear pressure between these two rolls to 95 N/mm. The roll 1 had an outer diameter of 100 mm, and an embossed pattern of diagonal lattice with a density of 100 meshes/inch and a depth of 0.010 mm. Its surface temperature was adjusted to 80° C. The roll 2 had an outer diameter of 200 mm and a plain surface. Its surface temperature was adjusted to room temperature.

Then, removal by extraction, removal by drying, and thermal fixation were performed under the same conditions to Example 1 to obtain a polyolefin porous membrane.

### Example 21

A gel sheet was obtained in the same manner as in Example 1. Then, the gel sheet was, without embossing, subjected to biaxial stretching, removal by extraction, removal by drying, and thermal fixation under the same conditions to Example 1 to obtain a film having a thickness of 25 μm.

The film was then passed between an embossing roll (roll 1) and a backup roll (roll 2) and embossed while adjusting the linear pressure between these two rolls to 95 N/mm to obtain a polyolefin microporous membrane. The roll 1 had an outer diameter of 100 mm, and an embossed pattern of diagonal lattice with a density of 100 meshes/inch and a depth of 0.010 mm. Its surface temperature was adjusted to 80° C. The roll 2 had an outer diameter of 200 mm and a plain surface. Its surface temperature was adjusted to room temperature.

### Example 22

After a gel sheet was obtained in the same manner as in Example 1, the gel sheet was embossed under the same conditions to Example 1 except that the surface temperature of the roll 1 was adjusted to 140° C.

Next, the gel sheet was subjected to biaxial stretching, removal by extraction, removal by drying, and thermal fixation as in Example 1 to obtain a polyolefin microporous membrane having a thickness of 24 μm.

### Example 23

An unprocessed film was prepared in the same manner as described in Example 16. The resulting unprocessed film was embossed under the same conditions to Example 16 except that the surface temperature of the roll 1 was adjusted to 143° C., a processed film was obtained.

Next, the film was subjected to stretching in MD, stretching in TD, and heat treatment in the same manner with Example 16 to obtain a polyolefin microporous membrane.

### Example 24

### Wound Electrode Plate Having a Diameter Adjusted to 17.8 mm

A wound electrode plate was prepared by using the polyolefin microporous membrane obtained in Example 5 and adjusting the length of the polyolefin microporous membrane, strip positive electrode, and strip negative electrode so that the diameter of the wound electrode plate became 17.8 mm. The initial discharge capacity and capacity retention ratio of it were evaluated.

### Example 25

### Wound Electrode Plate Having a Diameter Adjusted to 17.8 mm

A wound electrode plate was prepared by using the polyolefin microporous membrane obtained in Example 13 and adjusting the length of the polyolefin microporous membrane, strip positive electrode, and strip negative electrode so that the diameter of the wound electrode plate became 17.8 mm. The initial discharge capacity and capacity retention ratio of it were evaluated.

### Example 26

### Wound Electrode Plate Having a Diameter Adjusted to 17.8 mm

A polyolefin microporous membrane was obtained in the same manner as in Example 5 except that the thickness of the gel sheet was changed to 2400 μm and the depth of the embossed pattern of the roll 1 was changed to 1.8 mm. A wound electrode plate was prepared by adjusting the length of the polyolefin microporous membrane, strip positive electrode, and strip negative electrode so that the diameter of the wound electrode plate became 17.8 mm. The initial discharge capacity and capacity retention ratio of it were evaluated.

### Example 27

### Wound Electrode Plate Having a Diameter Adjusted to 17.8 mm

A polyolefin microporous membrane was obtained in the same manner as in Example 5 except that the thickness of the gel sheet was changed to 3000 μm, and meshe density and the depth of the embossed pattern of the roll 1 were changed to 100/inch and 2.2 mm, respectively. A wound electrode plate was prepared by adjusting the length of the polyolefin microporous membrane, strip positive electrode, and strip negative electrode so that the diameter of the wound electrode plate became 17.8 mm. The initial discharge capacity and capacity retention ratio of it were evaluated.

### Comparative Example 4

A polymer-containing mixture obtained by mixing 100 parts by weight of HDPE (“HI-ZEX7000FP”, product of Mitsui Chemicals, weight-average molecular weight: 200000, density: 0.956 g/cm³, melt flow rate: 0.04 g/10 min), 9 parts by weight of soft polypropylene (“PER R110E”, product of Idemitsu Petrochemical, weight-average molecular weight: 330000), 9 parts by weight of a hydrogenated castor oil (“HY-CASTOR OIL”, product of Hokoku Corporation, molecular weight: 938), and 150 parts by weight of barium sulfate (number-based average particle size: 0.17 μm) as an inorganic filler and then, melting and kneading the resulting mixture was subjected to blown-film inflation at 215° C. to obtain a sheet having a thickness of 45 μm.

The raw sheet thus obtained was stretched at a draw magnification of 2.2 in MD at 92° C. and then, stretched at a draw magnification of 3 at 121° C. in the same direction to obtain a polyolefin microporous membrane having a thickness of 18 μm, a porosity of 44%, an average pore diameter of 0.08 μm, and an air permeability of 170 sec/100 cc.

### Comparative Example 5

### An Alloy Negative Electrode Obtained by Plating was Used as Negative Electrode

By using the polyolefin microporous membrane described in Comparative Example 1 and the negative electrode described in Example 18, the battery performance and electrolyte retention condition were evaluated.

### Comparative Example 6

### A Carbon Negative Electrode was Used as a Negative Electrode

In the same manner as in Example 19 except for the use of the polyolefin microporous membrane described in Comparative Example 1 instead, the battery performance and the electrolyte retention condition were evaluated.

Various physical properties of the polyolefin microporous membranes prepared in Examples 1 to 17, Examples 20 to 24, and Comparative Examples 1 to 4 and the performances (battery capacity retention ratio and electrolyte retention condition) of the batteries using them as a separator are shown in Table 1.

The mark “-” in Table 1 means that the protrusion height or density is below the detection limit.

TABLE 1

| | Embossed pattern, | | | | Density of | | | | | |
|---|---|---|---|---|---|---|---|---|---|---|
| | density (meshes/ | | Protrusion | | protrusions | | | | | |
| | inch), | | height (μm) | | (pieces/cm²) | | X ratio | | | Pore |
| | depth (mm) | | Roll 1 | Roll 2 | Roll 1 | Roll 2 | Roll 1 | Roll 2 | Thickness | diameter |
| | Roll 1 | Roll 2 | side | side | side | side | side | side | (μm) | (μm) |
| Ex. 1 | Diagonal | Plain | 4.1 | — | 3 | — | 1.003 | <1.0001 | 24 | 0.075 |
| | lattice, | | | | | | | | | |
| | 25, | | | | | | | | | |
| | 0.225 | | | | | | | | | |
| Ex. 2 | Diagonal | Plain | 3.2 | — | 14 | — | 1.004 | <1.0001 | 16 | 0.058 |
| | lattice, | | | | | | | | | |
| | 54, | | | | | | | | | |
| | 0.16 | | | | | | | | | |
| Ex. 3 | Diagonal | Diagonal | 2.1 | 2.2 | 18 | 18 | 1.003 | 1.004 | 17 | 0.059 |
| | lattice, | lattice, | | | | | | | | |
| | 64, | 64, | | | | | | | | |
| | 0.102 | 0.102 | | | | | | | | |
| Ex. 4 | Diagonal | Plain | 2.1 | — | 18 | — | 1.003 | <1.0001 | 16 | 0.060 |
| | lattice, | | | | | | | | | |
| | 64, | | | | | | | | | |
| | 0.102 | | | | | | | | | |
| Ex. 5 | Diamond, | Plain | 14.8 | — | 740 | — | 1.153 | <1.0001 | 21 | 0.058 |
| | 400, | | | | | | | | | |
| | 1.2 | | | | | | | | | |
| Ex. 6 | Diagonal | Diamond, | 4.6 | 0.9 | 3 | 390 | 1.003 | 1.007 | 20 | 0.056 |
| | lattice, | 300, | | | | | | | | |
| | 25, | 0.03 | | | | | | | | |
| | 0.225 | | | | | | | | | |
| Ex. 7 | Diagonal | Plain | 2.5 | — | 45 | — | 1.006 | <1.0001 | 9 | 0.057 |
| | lattice, | | | | | | | | | |
| | 100, | | | | | | | | | |
| | 0.107 | | | | | | | | | |
| Ex. 8 | Diamond, | Plain | 1.1 | — | 390 | — | 1.008 | <1.0001 | 9 | 0.057 |
| | 300, | | | | | | | | | |
| | 0.03 | | | | | | | | | |
| Ex. 9 | Diagonal | Plain | 2.0 | — | 15 | — | 1.003 | <1.0001 | 17 | 0.067 |
| | lattice, | | | | | | | | | |
| | 100, | | | | | | | | | |
| | 0.107 | | | | | | | | | |
| Ex. 10 | Diagonal | Plain | 2.1 | — | 15 | — | 1.003 | <1.0001 | 18 | 0.065 |
| | lattice, | | | | | | | | | |
| | 100, | | | | | | | | | |
| | 0.107 | | | | | | | | | |
| Ex. 11 | Diagonal | Diamond, | 2.1 | 3.2 | 5 | 110 | 1.002 | 1.013 | 17 | 0.067 |
| | lattice, | 300, | | | | | | | | |
| | 54, | 0.03 | | | | | | | | |
| | 0.16 | | | | | | | | | |
| Ex. 12 | Diagonal | Plain | 2.5 | — | 44 | — | 1.006 | <1.0001 | 31 | 0.051 |
| | lattice, | | | | | | | | | |
| | 100, | | | | | | | | | |
| | 0.107 | | | | | | | | | |
| Ex. 13 | Diamond, | Plain | 19.3 | — | 740 | — | 1.199 | <1.0001 | 26 | 0.057 |
| | 400, | | | | | | | | | |
| | 1.5 | | | | | | | | | |
| Ex. 14 | Diagonal | Plain | 3.0 | — | 170 | — | 1.010 | <1.0001 | 17 | 0.105 |
| | lattice, | | | | | | | | | |
| | 100, | | | | | | | | | |
| | 0.107 | | | | | | | | | |
| Ex. 15 | Diagonal | Plain | 2.1 | 1.3 | 620 | 620 | 1.028 | 1.012 | 21 | 0.101 |
| | lattice, | | | | | | | | | |
| | 200, | | | | | | | | | |
| | 0.042 | | | | | | | | | |
| Ex. 16 | Diagonal | Plain | 5.2 | — | 1370 | — | 1.073 | <1.0001 | 18 | 0.887 |
| | lattice, | | | | | | | | | |
| | 200, | | | | | | | | | |
| | 0.042 | | | | | | | | | |
| Ex. 17 | Diagonal | Plain | 19.8 | — | 2060 | — | 1.342 | <1.0001 | 50 | 0.722 |
| | lattice, | | | | | | | | | |
| | 100, | | | | | | | | | |
| | 0.107 | | | | | | | | | |
| Ex. 20 | Diagonal | Plain | 3.9 | — | 1940 | — | | | 22 | 0.074 |
| | lattice, | | | | | | | | | |
| | 100, | | | | | | | | | |
| | 0.010 | | | | | | | | | |
| Ex. 21 | Diagonal | Plain | 4.0 | — | 1550 | — | | | 20 | 0.076 |
| | lattice, | | | | | | | | | |
| | 100, | | | | | | | | | |
| | 0.010 | | | | | | | | | |
| Ex. 22 | Diagonal | Plain | 4.3 | — | 3 | — | | | 24 | 0.074 |
| | lattice, | | | | | | | | | |
| | 25, | | | | | | | | | |
| | 0.225 | | | | | | | | | |
| Ex. 23 | Diagonal | Plain | 5.0 | — | 1370 | — | | | 18 | 0.885 |
| | lattice, | | | | | | | | | |
| | 200, | | | | | | | | | |
| | 0.042 | | | | | | | | | |
| Comp. | No embossing | | — | — | — | — | <1.0001 | <1.0001 | 25 | 0.073 |
| Ex. 1 | | | | | | | | | | |
| Comp. | Press with plain roll | | — | — | — | — | <1.0001 | <1.0001 | 24 | 0.075 |
| Ex. 2 | | | | | | | | | | |
| Comp. | Honey- | Plain | 8.3 | — | 0.02 | — | 1.0002 | <1.0001 | 25 | 0.074 |
| Ex. 3 | comb, 2 | | | | | | | | | |
| | 0.45 | | | | | | | | | |

| | | | | | | | |
|---|---|---|---|---|---|---|---|
| Comp. | Inorganic filler | 2.0 | 2.1 | 520 | 530 | 18 | 0.080 |
| Ex. 4 | | | | | | | |

| | | | | Tensile | | Tensile | | | |
|---|---|---|---|---|---|---|---|---|---|
| | | Air | Puncture | strength | | elongation | | Capacity | Electrolyte |
| | Porosity | permeability | strength | (kg/cm²) | | (%) | | retention | retention |
| | (%) | (sec) | (N/μm) | MD | TD | MD | TD | (%) | condition |
| Ex. 1 | 46 | 210 | 0.21 | 1010 | 1080 | 71 | 84 | 79 | Good |
| Ex. 2 | 37 | 266 | 0.32 | 1630 | 1350 | 73 | 120 | 80 | Good |
| Ex. 3 | 39 | 270 | 0.33 | 1650 | 1320 | 72 | 118 | 81 | Good |
| Ex. 4 | 39 | 245 | 0.29 | 1580 | 1290 | 70 | 114 | 79 | Good |
| Ex. 5 | 40 | 330 | 0.32 | 1810 | 1540 | 98 | 102 | 78 | Good |
| Ex. 6 | 41 | 340 | 0.33 | 1850 | 1610 | 101 | 105 | 82 | Good |
| Ex. 7 | 34 | 321 | 0.36 | 2030 | 1170 | 48 | 110 | 81 | Good |
| Ex. 8 | 35 | 318 | 0.38 | 2025 | 1160 | 47 | 116 | 80 | Good |
| Ex. 9 | 43 | 248 | 0.37 | 1820 | 1610 | 82 | 112 | 82 | Good |
| Ex. 10 | 44 | 240 | 0.35 | 1790 | 1500 | 80 | 110 | 80 | Good |
| Ex. 11 | 44 | 258 | 0.39 | 1870 | 1690 | 83 | 116 | 81 | Good |
| Ex. 12 | 42 | 492 | 0.66 | 1220 | 810 | 58 | 101 | 83 | Good |
| Ex. 13 | 41 | 330 | 0.32 | 1820 | 1530 | 97 | 102 | 81 | Good |
| Ex. 14 | 53 | 73 | 0.35 | 2450 | 330 | 36 | 195 | 80 | Good |
| Ex. 15 | 58 | 65 | 0.33 | 2430 | 320 | 34 | 192 | 83 | Good |
| Ex. 16 | 48 | 59 | 0.32 | 2460 | 330 | 36 | 194 | 84 | Good |
| Ex. 17 | 42 | 132 | 0.44 | 3750 | 470 | 42 | 210 | 82 | Good |
| Ex. 20 | 41 | 1820 | 0.23 | 1020 | 1100 | 72 | 85 | 81 | Good |
| Ex. 21 | 35 | 2170 | 0.22 | 980 | 1010 | 62 | 71 | 81 | Good |
| Ex. 22 | 44 | 2420 | 0.22 | 1040 | 1120 | 73 | 86 | 80 | Good |
| Ex. 23 | 47 | 3660 | 0.34 | 2510 | 360 | 38 | 197 | 80 | Good |
| Comp. | 47 | 205 | 0.17 | 920 | 1060 | 61 | 69 | 62 | Loss of |
| Ex. 1 | | | | | | | | | electrolyte |
| Comp. | 48 | 225 | 0.22 | 1060 | 1180 | 78 | 90 | 61 | Loss of |
| Ex. 2 | | | | | | | | | electrolyte |
| Comp. | 47 | 204 | 0.21 | 990 | 1120 | 71 | 83 | 64 | Loss of |
| Ex. 3 | | | | | | | | | electrolyte |
| Comp. | 44 | 170 | 0.16 | 2160 | 120 | 61 | 830 | 60 | Loss of |
| Ex. 4 | | | | | | | | | electrolyte |

The performances of batteries using, as a separator thereof, the polyolefin microporous membrane produced in Example 1 or Comparative Example 1 with different in the kind of a negative electrode (Examples 18, 19 and Comparative Examples 5 and 6) are shown in Table 2.

The mark “-” in Table 2 means that the protrusion height or density is below the detection limit.

TABLE 2

| | | Protrusion | | Density of | | | | | | | |
|---|---|---|---|---|---|---|---|---|---|---|---|
| | | height | | protrusions | | | | | | | |
| | Kind of | (μm) | | (pieces/cm²) | | Membrane | Pore | | Air | Capacity | Electrolyte |
| | negative | Roll 1 | Roll 2 | Roll 1 | Roll 2 | thickness | diameter | Porosity | permeability | retention | retention |
| | electrode | side | side | side | side | (μm) | (μm) | (%) | (sec) | (%) | condition |
| Ex. 1 | Alloy | 4.1 | — | 3 | — | 24 | 0.075 | 46 | 210 | 79 | Good |
| | negative | | | | | | | | | | |
| | electrode | | | | | | | | | | |
| Ex. 18 | Plating | 4.1 | — | 3 | — | 24 | 0.075 | 46 | 210 | 80 | Good |
| | alloy | | | | | | | | | | |
| | negative | | | | | | | | | | |
| | electrode | | | | | | | | | | |
| Ex. 19 | Carbon | 4.1 | — | 3 | — | 24 | 0.075 | 46 | 210 | 82 | Good |
| | negative | | | | | | | | | | |
| | electrode | | | | | | | | | | |
| Comp. | Alloy | — | — | — | — | 25 | 0.073 | 47 | 205 | 62 | Loss of |
| Ex. 1 | negative | | | | | | | | | | electrolyte |
| | electrode | | | | | | | | | | |
| Comp. | Plating | — | — | — | — | 25 | 0.073 | 47 | 205 | 61 | Loss of |
| Ex. 5 | alloy | | | | | | | | | | electrolyte |
| | negative | | | | | | | | | | |
| | electrode | | | | | | | | | | |
| Comp. | Carbon | — | — | — | — | 25 | 0.073 | 47 | 205 | 82 | Good |
| Ex. 6 | negative | | | | | | | | | | |
| | electrode | | | | | | | | | | |

The performances (initial discharge capacity and capacity retention ratio) of the wound electrode plates produced in Examples 24 to 26 are shown in Table 3.

The mark “-” in Table 3 means that the protrusion height or density is below a detection limit.

It is apparent from the results of Table 3 that with an increase in the protrusion height, the capacity retention ratio increases but the initial discharge capacity decreases. The capacity retention ratio did not exceed 82% even when the protrusion height was set at 21.2 μm or greater. This suggests that in view of balance the capacity retention ratio with initial discharge capacity, the protrusion height is preferably set at about 20 μm or less.

TABLE 3

| | | | | | Density of | | | |
|---|---|---|---|---|---|---|---|---|
| | Embossed pattern, | | Protrusion | | protrusion | | | |
| | density (meshed/ | | height (μm) | | (pieces/cm²) | | Membrane | Pore |
| | inch), depth (mm) | | Roll 1 | Roll 2 | Roll 1 | Roll 2 | thickness | diameter |
| | Roll 1 | Roll 2 | side | side | side | side | (μm) | (μm) |
| Ex. 24 | Diamond | Plain | 14.8 | — | 740 | — | 21 | 0.058 |
| | 400 | | | | | | | |
| | 1.2 | | | | | | | |
| Ex. 25 | Diamond | Plain | 19.3 | — | 740 | — | 26 | 0.057 |
| | 400 | | | | | | | |
| | 1.5 | | | | | | | |
| Ex. 26 | Diamond | Plain | 21.2 | — | 740 | — | 28 | 0.056 |
| | 400 | | | | | | | |
| | 1.8 | | | | | | | |
| Ex. 27 | Diamond | Plain | 27.9 | — | 740 | — | 35 | 0.055 |
| | 400 | | | | | | | |
| | 2.2 | | | | | | | |

| | | | | Initial discharge | | |
|---|---|---|---|---|---|---|
| | | | | capacity when the | | |
| | | Air | Puncture | diameter of wound | Capacity | Electrolyte |
| | Porosity | permeability | strength | electrode plate is set | retention | retention |
| | (%) | (sec) | (N/μm) | to 17.8 mm (mAh) | (%) | condition |
| Ex. 24 | 40 | 330 | 0.32 | 1980 | 78 | Good |
| Ex. 25 | 41 | 330 | 0.32 | 1880 | 81 | Good |
| Ex. 26 | 41 | 320 | 0.31 | 1840 | 82 | Good |
| Ex. 27 | 42 | 325 | 0.3 | 1720 | 82 | Good |

### BRIEF DESCRIPTION OF THE DRAWINGS

FIG. 1 illustrates observation results of the shape of protrusions of the polyolefin microporous membrane obtained in Example 3.

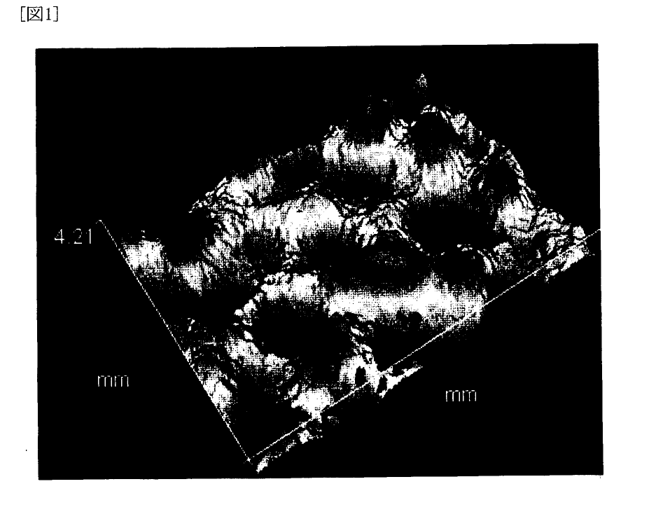

### INDUSTRIAL APPLICABILITY

The present invention relates to a microporous membrane widely used as a separation membrane for use in separation or selective transmission of substances or a separator material of an electrochemical reaction apparatus such as an alkaline battery, lithium ion battery, fuel cell, or capacitor. In particular, it is suited for use as a separator for nonaqueous electrolyte battery.

The polyolefin microporous membrane of the present invention and the polyolefin microporous membrane obtained using the production method of the present invention are particularly suited as a separator of batteries using, as the negative electrode thereof, an alloy negative electrode.

1. A polyolefin microporous membrane having a thickness of from 1 to 100 μm and a pore diameter of from 0.01 to 1 μm, and having embossed protrusions having a height of from 0.5 to 100 μm on at least one of the surfaces of the membrane.

2. The polyolefin microporous membrane according to claim 1, wherein the protrusions are porous.

3. The polyolefin microporous membrane according to claim 1 or 2, having an air permeability of from 1 to 450 sec.

4. The polyolefin microporous membrane according to claim 1 or 2, wherein the protrusion height is from 0.5 to 20 μm.

5. The polyolefin microporous membrane according to claim 1 or 2, wherein the membrane has an air permeability of from 1 to 340 sec and the protrusion height is from 0.5 to 20 μm.

6. The polyolefin microporous membrane according to claim 1 or 2, wherein the density of the protrusions is from 1 to 3000 pieces/cm².

7. The polyolefin microporous membrane according to claim 1 or 2, wherein the pore diameter is from 0.01 to 0.15 μm.

8. The polyolefin microporous membrane according to claim 1 or 2 obtained by a production method of a polyolefin microporous membrane comprising: (i) a step of melting, kneading and extruding a polyolefin resin and a plasticizer, or a polyolefin resin, a plasticizer and an inorganic agent, (ii) a step of stretching the extrudate thus obtained, and (iii) a step of extracting the plasticizer, or the plasticizer and the inorganic agent, wherein the production method comprises, prior to the stretching step (ii), a step of forming protrusions by embossing.

9. A polyolefin microporous membrane with protrusions on at least one of the surfaces of the membrane, having a thickness of from 1 to 100 μm, a pore diameter of from 0.01 to 1 μm, and an area ratio X of from 1.001 to 3 represented by the following formula:
X=S1/S2 (1)
(wherein, S1 represents an area of the surface of the membrane on a side having the protrusions and S2 represents a projected area corresponding to the same portion as S1).

10. A production method of a polyolefin microporous membrane, comprising (i) a step of melting, kneading and extruding a polyolefin resin and a plasticizer, or a polyolefin resin, a plasticizer and an inorganic agent, (ii) a step of stretching the extrudate thus obtained, and (iii) a step of extracting the plasticizer, or the plasticizer and the inorganic agent, which further comprises, prior to the stretching step (ii), a step of forming protrusions by embossing.

11. The production method according to claim 9, wherein the embossing is performed at a temperature not greater than the melting point of the polyolefin resin.

12. A separator for nonaqueous electrolyte battery, comprising the polyolefin microporous membrane as described in claim 1 or 2.

13. A separator for alloy negative electrode lithium battery, comprising the polyolefin microporous membrane as described in claim 1 or 2.

14. A nonaqueous electrolyte battery comprising a positive electrode and a negative electrode placed opposite to each other via a separator, wherein the separator for nonaqueous electrolyte battery as described in claim 12 is used.

15. A nonaqueous electrolyte battery comprising a positive electrode and a negative electrode placed opposite to each other via a separator, and an electrolyte filled in the battery,
wherein the negative electrode comprises a negative electrode active material comprising a metal or a semi-metal which can be alloyed with lithium, and wherein the separator for alloy negative electrode lithium battery as described in claim 13 is used.

16. A production method of a polyolefin microporous membrane, comprising:
(I) a step of forming a polyolefin-containing resin composition into a sheet;
(II) a step of stretching the resulting sheet,
(III) a step of making the sheet porous, and
(IV) a step of embossing at least one of the surfaces of the sheet, wherein the step (IV) is performed prior to the step (II).
